(19) United States
(12) Patent Application Publication
(10) Pub. No.: US 2022/0059109 A1
(43) Pub. Date: Feb. 24, 2022

(54) TRANSMISSION APPARATUS, TRANSMISSION METHOD, RECEPTION APPARATUS, AND RECEPTION METHOD

(71) Applicant: SONY GROUP CORPORATION, Tokyo (JP)

(72) Inventor: Gen ICHIMURA, Tokyo (JP)

(73) Assignee: SONY GROUP CORPORATION, Tokyo (JP)

(21) Appl. No.: 17/428,150

(22) PCT Filed: Feb. 18, 2020
(86) PCT No.: PCT/JP2020/006365

§ 371 Date: Aug. 3, 2021

(30) Foreign Application Priority Data
Feb. 27, 2019 (JP) 2019-034473

(51) Int. Cl. G10L 19/16; H04N 21/4363; G10L 19/008; H04N 21/439

(52) U.S. Cl. CPC G10L 19/167; H04N 21/4398; G10L 19/008; H04N 21/43635

(57) ABSTRACT

A compressed audio signal and a linear PCM signal are successfully simultaneously transmitted and reproduced. An audio signal continuous for each specified unit is transmitted to a reception side through a specified transmission line. The audio signal continuous for each specified unit is obtained by alternately arranging the audio signal in the specified unit, which includes a compressed audio signal, and the audio signal in the specified unit, which includes a linear PCM signal. For example, the specified unit is a subframe.

### TECHNICAL FIELD

The present technology relates to a transmission apparatus, a transmission method, a reception apparatus, and a reception method.

### BACKGROUND ART

Transmission of a linear PCM signal that is performed on the basis of the digital audio interface standard IEC 60958 is widely used. For example, Patent Literature 1 discloses IEC 60958. Further, transmission based on IEC 61937 in which a compressed audio signal is transmitted over an IEC 60958 protocol, is also prevalent and used for various audio codec transmissions.

The following are examples of such interfaces. A coaxial terminal and an optical output terminal are commercial products that are known as Sony Philips Digital Interfaces (SPDIFs). Further, the IEC 60958 protocol is mapped to formats of High-Definition Multimedia Interface (HDMI), Mobile High-definition Link (MHL), and DisplayPort, which are interfaces of multimedia including video, and these interfaces are commercially available.

### CITATION LIST

### Patent Literature

Patent Literature 1: Japanese Patent Application Laid-open No. 2009-130606

### DISCLOSURE OF INVENTION

### Technical Problem

When a television set is used as a transmission apparatus and an audio amplifier is used as a reception/reproduction apparatus, only sound of content appearing on a screen of the television set is transmitted to the audio amplifier to be reproduced. A compression audio codec is ordinarily used for the content, and a technology, such as multichannel audio and object-based audio, that enables a high-quality reproduction has been developed. In the case of the codec described above, there is a need for great digital signal processor (DSP) capabilities for decoding, or there is a need for an arrangement of a large number of speakers such as a 5.1-channel configuration.

Thus, ordinarily, a compressed audio signal is transmitted to an audio amplifier through a digital audio interface to cause the audio amplifier to reproduce sound, since decoding and reproduction that are performed in a television set are highly loaded. There are various forms of content such as content received by a broadcast, content that is obtained by playing back a medium such as a Blu-ray Disc to be input to a television set, and content streamed or downloaded via the Internet.

On the other hand, there is a need to reproduce sound in a television set not only for playback of content but also for other cases. Examples of such cases include a response sound of a user interface such as a remote controller, a synthesized sound that is obtained by synthesizing artificial speech and used for an artificial intelligence (AI) function and a navigational function, and a multi-language support (a plurality of languages is originally applied to content, and translation is performed in real time, for example, on the internet or in a television set). In most of those cases, there is a need for a real-time performance, compared to the case of playback of content. In this case, a linear PCM signal is transmitted to avoid a delay due to decoding. A similar situation also occurs when a digital audio transmission is performed between in-vehicle apparatuses in a vehicle.

Here, if switching is sequentially performed between transmission of a compressed audio signal and transmission of a linear PCM signal to perform reproduction, this will result in a significant loss of continuity of playback of content, and thus in a degradation in playback quality. It is also possible to decode a compressed audio signal, mix it with a linear PCM signal, and transmit a signal obtained by the mixture. However, a television set does not have the capability to decode all of the compressed audio signals. Further, a delay occurs in the process of decoding and mixture. This may be unfavorable for an application for which the real-time performance described above is necessary. For example, in the case of game content, background music is provided using MPEG-4 AAC, and it will be difficult for a user to feel comfortable playing a game if there is a delay in, for example, transmitting a linear PCM signal that is a response to an operation performed by the user through a game controller.

In other words, the problem is that a digital-audio-interface method or apparatus that enables simultaneous transmission and reproduction of a compressed audio signal and a linear PCM signal is not provided. For this reason, a low-quality speaker reproduction performed in a television set is applied only to a linear PCM signal. This results in significantly degrading user experience. Further, the problem will be solved if a plurality of digital audio interfaces is provided and a compressed audio signal and a linear PCM signal are transmitted to different audio amplifiers to perform reproduction. This will result in an increase in costs, and in more complicated apparatus settings. Consequently, a system that is unrealistic for general users is obtained.

It is an object of the present technology to successfully simultaneously transmit and reproduce a compressed audio signal and a linear PCM signal.

### Solution to Problem

A concept of the present technology provides a transmission apparatus that includes a transmission section that transmits an audio signal continuous for each specified unit to a reception side through a specified transmission line, the audio signal continuous for each specified unit being obtained by alternately arranging the audio signal in the specified unit, which includes a compressed audio signal, and the audio signal in the specified unit, which includes a linear PCM signal.

In the present technology, an audio signal continuous for each specified unit is transmitted to a reception side by a transmission section through a specified transmission line. For example, the specified transmission line may be one of a coaxial cable, an optical cable, an Ethernet (an IEC 61883-6) cable, an HDMI cable, an MHL cable, and a DisplayPort cable.

The audio signal continuous for each specified unit is obtained by alternately arranging the audio signal in the specified unit, which includes a compressed audio signal, and the audio signal in the specified unit, which includes a linear PCM signal. For example, the specified unit may be a subframe. Further, for example, the linear PCM signal may be an audio signal by which a real-time performance is to be ensured. Furthermore, a first acquisition section that acquires the compressed audio signal, and a second acquisition section that acquires the linear PCM signal may be further included.

As described above, in the present technology, an audio signal continuous for each specified unit is transmitted to a reception side through a specified transmission line, the audio signal continuous for each specified unit being obtained by alternately arranging the audio signal in the specified unit, which includes a compressed audio signal, and the audio signal in the specified unit, which includes a linear PCM signal. This makes it possible to successfully simultaneously transmit a compressed audio signal and a linear PCM signal.

Note that, in the present technology, for example, an information adder may be further included, the information adder adding, to the audio signal transmitted by the transmission section, identification information indicating that the audio signal transmitted by the transmission section is obtained by alternately arranging the audio signal in the specified unit, which includes a compressed audio signal, and the audio signal in the specified unit, which includes a linear PCM signal. In this case, for example, the information adder may add the identification information using a specified bit region in a channel status for each block, the specified bit region being assigned a specified number, the channel status being made up for each specified unit. Such an addition of the identification information enables the reception side to easily recognize that the audio signal continuous for each specified unit is obtained by alternately arranging the audio signal in the specified unit, which includes a compressed audio signal, and the audio signal in the specified unit, which includes a linear PCM signal.

Further, in the present technology, for example, an information adder may be further included, the information adder adding, to the audio signal transmitted by the transmission section, configuration information indicating a configuration of the linear PCM signal. In this case, for example, the information adder may add the configuration information using a specified bit region in a channel status for each block, the specified bit region being assigned a specified number, the channel status being made up for each specified unit. Such an addition of the configuration information enables the reception side to easily recognize the configuration of the linear PCM signal.

Furthermore, in the present technology, for example, an information adder may be further included, the adding, to the audio signal transmitted by the transmission section, information related to the linear PCM signal. In this case, for example, the information adder may add the information related to the linear PCM signal using consecutive user data bits in the specified unit, the consecutive user data bits being assigned a specified number. Such an addition of the information related to the linear PCM signal enables the reception side to appropriately perform processing on the linear PCM signal.

Further, another concept of the present technology provides a reception apparatus that includes a reception section that receives an audio signal continuous for each specified unit from a transmission side through a specified transmission line, the audio signal continuous for each specified unit being obtained by alternately arranging the audio signal in the specified unit, which includes a compressed audio signal, and the audio signal in the specified unit, which includes a linear PCM signal.

In the present technology, an audio signal continuous for each specified unit is received from a transmission side by a reception section a through a specified transmission line. The audio signal continuous for each specified unit is obtained by alternately arranging the audio signal in the specified unit, which includes a compressed audio signal, and the audio signal in the specified unit, which includes a linear PCM signal. For example, a processor may be further included, the processor performing processing on the compressed audio signal and the linear PCM signal to obtain an output linear PCM signal.

As described above, in the present technology, an audio signal continuous for each specified unit is received from a transmission side through a specified transmission line, the audio signal continuous for each specified unit being obtained by alternately arranging the audio signal in the specified unit, which includes a compressed audio signal, and the audio signal in the specified unit, which includes a linear PCM signal. This makes it possible to successfully simultaneously reproduce a compressed audio signal and a linear PCM signal.

Note that, in the present technology, for example, configuration information indicating a configuration of the linear PCM signal may be added to the audio signal received by the reception section, and the processor may perform processing on the linear PCM signal on the basis of the configuration information. This enables the processor to appropriately perform processing on the linear PCM signal according to the configuration of the linear PCM signal.

Further, in the present technology, for example, information related to the linear PCM signal may be added to the audio signal received by the reception section, and the processor may perform processing on the linear PCM signal on the basis of the information related to the linear PCM signal. This enables the processor to appropriately perform processing on the linear PCM signal according to the information related to the linear PCM signal.

### BRIEF DESCRIPTION OF DRAWINGS

FIG. 1 is a block diagram illustrating an example of a configuration of an AV system according to embodiments.

FIG. 2 illustrates examples of language names displayed on a display section of an audio amplifier.

FIG. 3 is a block diagram illustrating examples of configurations of an HDMI reception section of a television set and an HDMI transmission section of the audio amplifier.

FIG. 4 illustrates periods for various pieces of transmission data when image data with 1920 pixels in width and 1080 lines in height is transmitted over a TMDS channel.

FIG. 5 illustrates a pin arrangement of an HDMI connector.

FIG. 6 illustrates an example of a configuration of a high-speed bus interface of the television set.

FIG. 7 illustrates an example of a configuration of a high-speed bus interface of the audio amplifier.

FIG. 8 illustrates a configuration of a frame in the IEC 60958 standard.

FIG. 9 illustrates a configuration of a subframe in the IEC 60958 standard.

FIG. 10 illustrates a signal modulation scheme in the IEC 60958 standard.

FIG. 11 illustrates channel coding of a preamble in the IEC 60958 standard.

FIG. 12 illustrates an IEC 61937-1 interface format.

FIG. 13 illustrates an interface format (a first method) when a compressed audio signal and a linear PCM signal are simultaneously transmitted.

FIG. 14 schematically illustrates a format of a channel status that corresponds to the interface format (the first method).

FIG. 15 illustrates an example of a correspondence relationship between a value “Subframe configuration value (SCV)” and a configuration of a linear PCM signal.

FIG. 16 illustrates an example of a configuration of a frame when the entirety of a stream is transmitted at 48 kHz and when a linear PCM signal has a configuration of “mono LPCM”.

FIG. 17 illustrates an example of a configuration of a frame when the entirety of a stream is transmitted at 96 kHz and when a linear PCM signal has a configuration of “2-channel stereo LPCM”.

FIG. 18 illustrates an example of a configuration of a frame when the entirety of a stream is transmitted at 96 kHz and when a linear PCM signal has a configuration of “mono LPCM”.

FIG. 19 illustrates an example of a configuration of a frame when a compressed audio signal and a linear PCM signal are alternately arranged for each frame.

FIG. 20 illustrates an interface format (a second method) when a compressed audio signal and a linear PCM signal are simultaneously transmitted.

FIG. 21 schematically illustrates a format of a channel status that corresponds to the interface format (the second method).

FIG. 22 illustrates an example of a correspondence relationship between a value “Multichannel configuration value (MCV)” and a configuration of a linear PCM signal.

FIG. 23 illustrates examples of a configuration of a frame in the case of an 8-bit two-channel configuration and in the case of a 16-bit single-channel configuration.

FIG. 24 illustrates examples of a configuration of a frame in the case of a 16-bit two-channel configuration and in the case of a 16-bit two-channel stereo configuration.

FIG. 25 illustrates an example of a configuration of a frame when a two-channel stereo linear PCM signal and a 5.1-channel linear PCM signal are transmitted.

FIG. 26 illustrates an interface format when the first method and the second method are used in combination.

FIG. 27 illustrates an example of a user data message.

FIG. 28 illustrates an example of information related to a linear PCM signal.

FIG. 29 is a diagram for describing an operation performed when an operation of switching the sound (the language) is performed using the television set.

FIG. 30 is a block diagram illustrating an example of a configuration in which a game machine is connected to the television set to play a game.

FIG. 31 is a block diagram illustrating an example of a configuration in which a microphone is connected to the television set to sing a karaoke song.

FIG. 32 is a block diagram illustrating an example of a configuration in which a navigation system is used by being connected to the television set.

### MODE(S) FOR CARRYING OUT THE INVENTION

Embodiments for carrying out the present technology (hereinafter referred to as “embodiments”) will now be described below. Note that the description is made in the following order.
1. Embodiments
2. Modifications

### 1. Embodiments

[Example of Configuration of AV System]

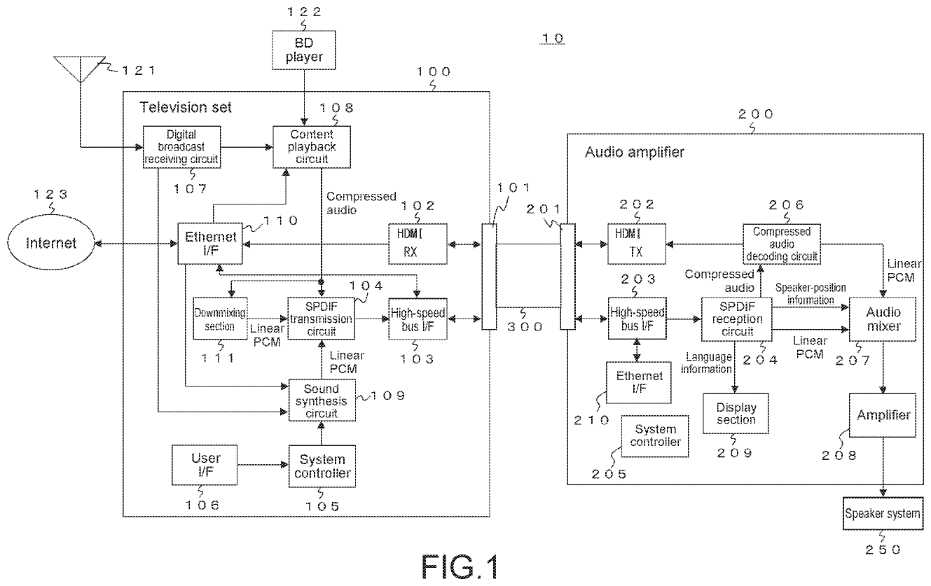

FIG. 1 illustrates an example of a configuration of an AV system 10 according to embodiments. The AV system 10 includes a television set 100 and an audio amplifier 200. A reception antenna 121 for a television broadcast, a Blu-ray Disc (BD) player 122, and the Internet 123 are connected to the television set 100. Further, a two-channel or multichannel speaker system 250 is connected to the audio amplifier 200. Note that “Blu-ray” is a registered trademark.

The television set 100 and the audio amplifier 200 are connected through an HDMI cable 300. Note that “HDMI” is a registered trademark. The television set 100 includes an HDMI terminal 101 to which an HDMI reception section (HDMI RX) 102, and a high-speed bus interface 103 that is included in a communication section are connected. The audio amplifier 200 includes an HDMI terminal 201 to which an HDMI transmission section (HDMI TX) 202, and a high-speed bus interface 203 that is included in the communication section are connected. One end of the HDMI cable 300 is connected to the HDMI terminal 101 of the television set 100, and the other end is connected to the HDMI terminal 201 of the audio amplifier 200.

The television set 100 includes the HDMI reception section 102, the high-speed bus interface 103, and an SPDIF transmission circuit 104. Further, the television set 100 includes a system controller 105, a user interface 106, a digital broadcast receiving circuit 107, a content playback circuit 108, a sound synthesis circuit 109, an Ethernet interface 110, and a downmixing section 111. Note that “Ethernet” is a registered trademark. Further, in the illustrated example, respective image-related components are omitted as necessary in order to simplifying the description.

The system controller 105 controls an operation of each component of the television set 100. The user interface 106 is connected to the system controller 105. The user interface 106 is included in an operation section used by a user to perform various operations, and includes, for example, a remote controller, a touch panel, a mouse, a keyboard, a gesture input section that detects an instruction input using a camera, and a voice input section that performs an instruction input using voice.

The digital broadcast receiving circuit 107 performs processing on a television broadcast signal input from the reception antenna 121, and outputs a compressed audio signal related to broadcast content. The Ethernet interface 110 communicates with another server through the Internet 123. The content playback circuit 108 selectively extracts a compressed audio signal for broadcast content that is obtained by the digital broadcast receiving circuit 107, a compressed audio signal for playback content that is supplied by the BD player 122, or a compressed audio signal for Internet content that is obtained through the Ethernet interface 110, and transmits the extracted compressed audio signal to the SPDIF transmission circuit 104.

The sound synthesis circuit 109 receives, from the system controller 105, data of an operation sound corresponding to an operation performed on the user interface 106, generates a linear PCM signal for an operation sound, and transmits the generated linear PCM signal to the SPDIF transmission circuit 104. A real-time performance is to be ensured by such a linear PCM signal for an operation sound. Further, the sound synthesis circuit 109 receives, from the system controller 105, data of a notification sound used to notify a user that an e-mail has been received, generates a linear PCM signal for a notification sound, and transmits the generated linear PCM signal to the SPDIF transmission circuit 104.

Further, the sound synthesis circuit 109 receives subtitled data from the digital broadcast receiving circuit 107, generates a linear PCM signal for a subtitle sound using subtitle reading software, and transmits the generated linear PCM signal to the SPDIF transmission circuit 104. A real-time performance is to be ensured by such a linear PCM signal for a subtitle sound. Examples of such a case include a case in which the broadcast content is a foreign film, the language of sound provided by a compressed audio signal is a foreign language, and the foreign film is a film with Japanese subtitles. Note that, with respect to the subtitle sound, the same applies to a case in which there is subtitle data for playback content from the BD player 122, instead of broadcast content.

Furthermore, the sound synthesis circuit 109 receives text data of a translation sound received from a translation server (not illustrated in FIG. 1) through the Ethernet interface 110, generates a linear PCM signal for a translation sound, and transmits the generated linear PCM signal to the SPDIF transmission circuit 104.

Here, for example, the Ethernet interface 110 receives, through the HDMI transmission section 202 of the audio amplifier 200 and the HDMI reception section 102 of the television set 100, a PCM sound signal for a line in a first language that is obtained by a compressed audio decoding circuit 206 of the audio amplifier 200 that will be described later, and transmits the PCM sound signal for the line in the first language to the translation server to receive text data of a translation sound of a line in a second language from the translation server.

The downmixing section 111 performs processing of decoding and downmixing on a multichannel compressed audio signal extracted by the content playback circuit 108 to generate a two-channel linear PCM stereo signal, and transmits the generated signal to the SPDIF transmission circuit 104. This enables simultaneous transmission of a multichannel compressed audio signal and a two-channel linear PCM stereo signal from the SPDIF transmission circuit 104. In this case, a determination of which of the signals is to be reproduced is performed by a reception side. In the illustrated example, only the audio amplifier 200 is a reproducer of the reception side, but this approach is effective when reproducers having different reproduction capabilities are placed in respective rooms of a plurality of rooms.

The HDMI reception section 102 performs a communication based on HDMI to receive image data and sound data that are supplied to the HDMI terminal 101 through the HDMI cable 300. The high-speed bus interface 103 is an interface for a two-way communication path formed using a reserve line and a hot-plug-detect (HPD) line that are included in the HDMI cable 300. Note that the HDMI reception section 102 and the high-speed bus interface 103 will be described in detail later.

The SPDIF transmission circuit 104 is a circuit used to transmit a digital audio transmission signal compliant with the IEC 60958 standard (hereinafter referred to as an “SPDIF signal” as appropriate). The SPDIF transmission circuit 104 is a transmission circuit compliant with the IEC 60958 standard. Note that the SPDIF signal will be described in detail later.

In the present embodiment, the SPDIF transmission circuit 104 simultaneously transmits a compressed audio signal and a linear PCM signal. Here, there are a first method and a second method that are conceivable methods for simultaneously transmitting a compressed audio signal and a linear PCM signal.

In the first method, an audio signal that is continuous for each subframe is obtained by alternately arranging an audio signal for each subframe that includes a compressed audio signal, and an audio signal for each subframe that includes a linear PCM signal.

In this case, identification information indicating a configuration of an audio signal (an audio signal that is continuous for each subframe is obtained by alternately arranging an audio signal for each subframe that includes a compressed audio signal, and an audio signal for each subframe that includes a linear PCM signal), configuration information indicating a configuration of the linear PCM signal, information related to the linear PCM signal, and the like are added to an SPDIF signal transmitted from the SPDIF transmission circuit 104. Examples of what is indicated by the configuration information include mono, two-channel stereo, 5.1 channel, and 7.1 channel. Further, examples of the information related to a linear PCM signal include language information and speaker-position information.

In the second method, an audio signal for each subframe is a mixture signal of a compressed audio signal and a linear PCM signal.

In this case, identification information indicating a configuration of an audio signal (an audio signal for each subframe is a mixture signal of a compressed audio signal and a linear PCM signal), configuration information indicating a configuration of the linear PCM signal, information related to the linear PCM signal, and the like are added to an SPDIF signal transmitted from the SPDIF transmission circuit 104. Examples of what is indicated by the configuration information include a two-channel configuration of an 8-bit linear PCM signal, a two-channel stereo configuration of an 8-bit linear PCM signal, and a one-channel configuration of a 16-bit linear PCM signal. Further, examples of the information related to a linear PCM signal include language information and speaker-position information.

The audio amplifier 200 includes the HDMI transmission section 202, the high-speed bus interface 203, and an SPDIF reception circuit 204. Further, the audio amplifier 200 includes a system controller 205, the compressed audio decoding circuit 206, an audio mixer 207, an amplifier 208, a display section 209, and an Ethernet interface 210.

The system controller 205 controls an operation of each component of the audio amplifier 200. The HDMI transmission section 202 performs a communication based on HDMI to transmit baseband video (image) data and baseband sound data to the HDMI cable 300 via the HDMI terminal 201. The high-speed bus interface 203 is an interface for a two-way communication path formed using a reserve line and a hot-plug-detect (HPD) line that are included in the HDMI cable 300. Note that the HDMI transmission section 202 and the high-speed bus interface 203 will be described in detail later.

The SPDIF reception circuit 204 is a circuit used to receive an SPDIF signal (a digital audio signal compliant with the IEC 60958 standard). The SPDIF reception circuit 204 is a reception circuit compliant with the IEC 60958 standard. On the basis of identification information indicating a configuration of an audio signal, the SPDIF reception circuit 204 splits the audio signal to acquire a compressed audio signal and a linear PCM signal.

The compressed audio decoding circuit 206 performs decoding processing on the compressed audio signal obtained by the SPDIF reception circuit 204 to obtain a two-channel or multichannel linear PCM signal.

On the basis of configuration information indicating a configuration of a linear PCM signal, the audio mixer 207 mixes the linear PCM signal obtained by the SPDIF reception circuit 204 with the linear PCM signal obtained by the compressed audio decoding circuit 206 to obtain a two-channel or multichannel output linear PCM signal.

Note that processing of the mixture as used herein includes selecting only one of the linear PCM signals. Further, the processing of the mixture as used herein includes selecting, when linear PCM signals for a plurality of channels are transmitted, one of the linear PCM signals.

Here, the audio mixer 207 performs rendering processing such that a PCM sound signal for a channel suitable for a configuration of the speaker system 250 is obtained. Further, when, for example, speaker-position information is added to a linear PCM signal obtained by the SPDIF reception circuit 204 as information related to the linear PCM signal, the audio mixer 207 performs rendering processing such that sound provided by the linear PCM signal is localized at the speaker position. The amplifier 208 amplifies a two-channel or multichannel output linear PCM signal obtained by the audio mixer 207 to supply the amplified signal to the speaker system 250.

Note that, for example, information indicating that speaker-position information set in advance is applied may be added to configuration information indicating a configuration of a linear PCM signal. In this case, the speaker-position information set in advance can be used.

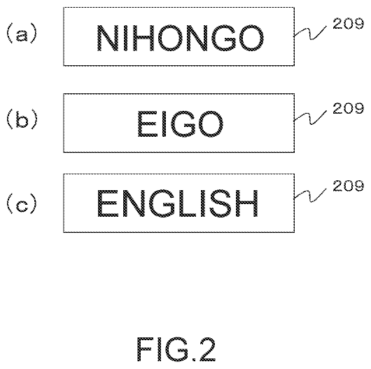

The display section 209 displays thereon, for example, a state of the audio amplifier 200. When, for example, a linear PCM signal from the compressed audio decoding circuit 206 is a signal for sound in a first language, and a linear PCM signal obtained by the SPDIF circuit 204 is a signal for sound in a second language, the audio mixer 207 selects one of the linear PCM signals, and a language name related to the selected linear PCM signal is displayed on the display section 208. Here, information regarding a language of sound provided by the linear PCM signal from the compressed audio decoding circuit 206 is embedded in a compressed audio signal itself, whereas information regarding a language of sound provided by the linear PCM signal obtained by the SPDIF circuit 204 is added to an audio signal received by the SPDIF reception circuit 204. (a), (b), and (c) of FIG. 2 each illustrate an example of a language name displayed on the display section 209.

“Examples of Configurations of HDMI Transmission Section and HDMI Reception Section”

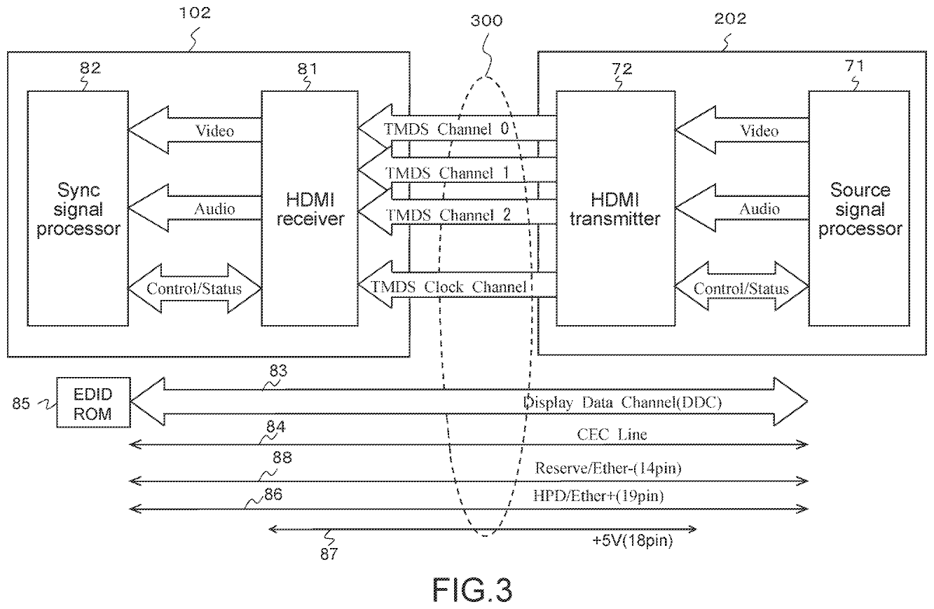

FIG. 3 illustrates examples of configurations of the HDMI reception section 102 of the television set 100 and the HDMI transmission section 202 of the audio amplifier 200 in the AV system 10 of FIG. 1.

The HDMI transmission section 202 transmits a differential signal for a single screen of baseband (uncompressed) image data to the HDMI reception section 102 over a plurality of channels in a single direction in a valid image period (hereinafter referred to as an “active video period”) that is a period obtained by excluding a horizontal blanking period and a vertical blanking period from a period between a certain vertical synchronization signal to a next vertical synchronization signal (hereinafter referred to as a “video field” as appropriate). Further, the HDMI transmission section 202 transmits a differential signal to the HDMI reception section 102 over a plurality of channels in a single direction in the horizontal blanking period and in the vertical blanking period, the differential signal corresponding to auxiliary data including sound data, a control packet, and others that are associated with the image data.

The HDMI transmission section 202 includes a source signal processor 71 and an HDMI transmitter 72. The source signal processor 71 is supplied with baseband uncompressed image (video) data and baseband uncompressed sound (audio) data. The source signal processor 71 performs necessary processing on the supplied image data and sound data, and supplies the HDMI transmitter 72 with the pieces of data on which the necessary processing has been performed. Further, the source signal processor 71 exchanges, for example, control information and status-notification information (control/status) with the HDMI transmitter 72 as necessary.

The HDMI transmitter 72 converts the image data supplied by the source signal processor 71 into a corresponding differential signal, and transmits the differential signal to the HDMI reception section 102 over a plurality of channels, that is, three TMDS channels #0, #1, and #2 in a single direction, the HDMI reception section 102 being connected to the HDMI transmission section 202 through the HDMI cable 300.

Further, the transmitter 72 converts the auxiliary data and control data into respective differential signals, the auxiliary data being supplied by the source signal processor 71 and including the sound data, the control packet, and others that are associated with the uncompressed image data, the control data being used to control a vertical synchronization signal (VSYNC) and a horizontal synchronization signal (HSYNC). The source signal processor 71 transmits the differential signals to the HDMI reception section 102 over the three TMDS channels #0, #1, and #2 in a single direction, the HDMI reception section 102 being connected to the HDMI transmission section 202 through the HDMI cable 300.

Further, the transmitter 72 transmits a pixel clock to the HDMI reception section 102 over a TMDS clock channel, the pixel clock being synchronized with the image data transmitted over the three TMDS channels #0, #1, and #2, the HDMI reception section 102 being connected to the HDMI transmission section 202 through the HDMI cable 300.

The HDMI reception section 102 receives a differential signal that corresponds to image data and is transmitted from the HDMI transmission section 202 over a plurality of channels in a single direction in an active video period. Further, the HDMI reception section 102 receives differential signals that respectively correspond to auxiliary data and control data and are transmitted from the HDMI transmission section 202 over the plurality of channels in a horizontal blanking period and in a vertical blanking period.

The HDMI reception section 102 includes an HDMI receiver 81 and a sync signal processor 82. The HDMI receiver 81 receives a differential signal corresponding to image data and differential signals respectively corresponding to auxiliary data and control data in synchronization with a pixel clock, the differential signal corresponding to image data, and the differential signals respectively corresponding to auxiliary data and control data being transmitted from the HDMI transmission section 202 over the TMDS channels #0, #1, and #2 in a single direction, the pixel clock also being transmitted from the HDMI transmission section 202 over the TMDS clock channel, the HDMI transmission section 202 being connected to the HDMI reception section 102 through the HDMI cable 300. Further, the HDMI receiver 81 converts the differential signals into image data, auxiliary data, control data, respectively, and supplies the obtained pieces of data to the sync signal processor 82 as necessary.

The sync signal processor 82 performs necessary processing on data supplied by the HDMI receiver 81, and outputs the data on which the processing has been performed. Further, the sync signal processor 82 exchanges, for example, control information and status-notification information (control/status) with the HDMI receiver 81 as necessary.

The three TMDS channels #0, #1, and #2 being used to serially transmit image data, auxiliary data, and control data in synchronization with a pixel clock from the HDMI transmission section 202 to the HDMI reception section 102 in a single direction, and the TMDS clock channel being a transmission channel used to transmit the pixel clock are HDMI transmission channels. In addition to those channels, transmission channels called a display data channel (DDC) 83 and a CEC line 84 are also HDMI transmission channels.

The DDC 83 includes two lines (signal lines) (not illustrated) that are included in the HDMI cable 300, and is used by a source device to read an enhanced-extended display identification (E-EDID) from a sync device that is connected to the source device through the HDMI cable 300. In other words, the sync device includes an EDID-ROM 85. The source device reads an E-EDID stored in the EDID-ROM 85 from the sync device through the DDC 83, the sync device being connected to the source device through the HDMI cable 300, and recognizes settings and a performance of the sync device on the basis of the read E-EDID.

The CEC line 84 includes a single line (not illustrated) that is included in the HDMI cable 300, and is used by the source device and the sync device to perform a two-way communication of control data.

Further, the HDMI cable 300 includes a line 86 that is connected to a hot plug detect (HPD) pin. The source device can detect a connection with the sync device using the line 86. Further, the HDMI cable 300 includes a line 87 that is used to supply power from the source device to the sync device. Moreover, the HDMI cable 300 includes a reserve line 88.

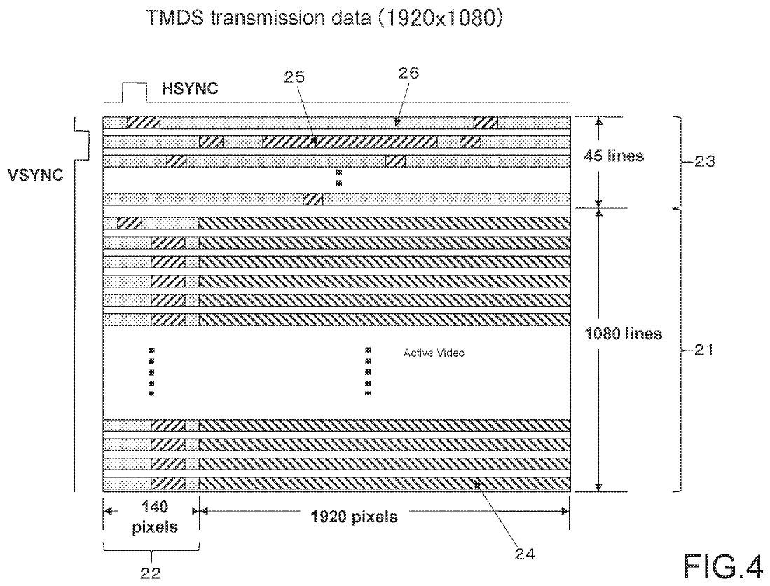

FIG. 4 illustrates periods for various pieces of transmission data when image data with 1920 pixels in width and 1080 lines in height is transmitted over a TMDS channel. Correspondingly to respective types of pieces of transmission data, there exist three types of periods in a video field in which transmission data is transmitted over three HDMI TMDS channels, the three types of periods being a video data period 24, a data island period 25, and a control period 26.

Here, a period of the video field is a period from a rising edge (an active edge) of a certain vertical synchronization signal to a rising edge of a next vertical synchronization signal, and the period of the video field is divided into a horizontal blanking period 22, a vertical blanking period 23, and a valid pixel period (an active video period) 21 that is a period obtained by excluding the horizontal blanking period and the vertical blanking period from the period of the video field.

The video data period 24 is allocated to the valid pixel period 21. Data of valid pixels (active pixels) for 1920 pixels and 1080 lines that make up a single screen of uncompressed image data is transmitted in the video data period 24. The data island period 25 and the control period 26 are allocated to the horizontal blanking interval 22 and the vertical blanking interval 23. Auxiliary data is transmitted in the data island period 25 and in the control period 26.

In other words, the data island period 25 is allocated to a portion of the horizontal blanking period 22 and a portion of the vertical blanking period 23. For example, a packet of sound data is transmitted in the data island period 25, the sound data being data, from among auxiliary data, that is not related to control. The control period 26 is allocated to another portion of the horizontal blanking period 22 and another portion of the vertical blanking period 23. For example, a control packet used to control a vertical synchronization signal and a horizontal synchronization signal is transmitted in the control period 26, the control packet being control-related data from among the auxiliary data.

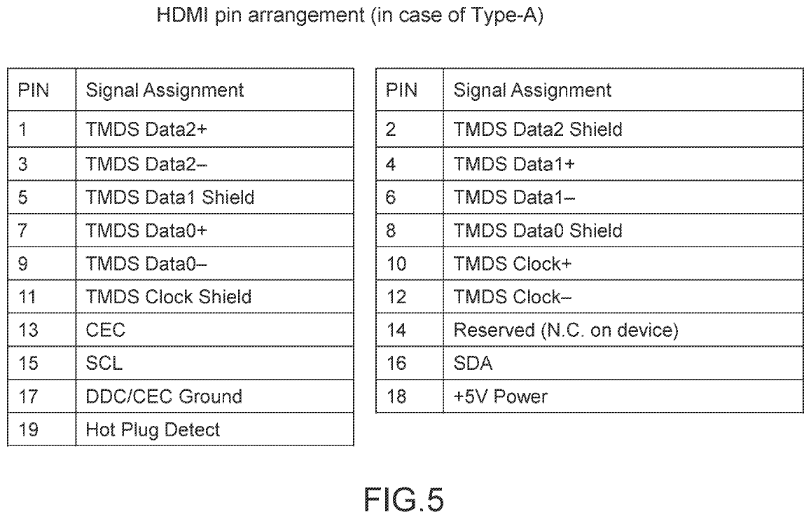

FIG. 5 illustrates a pin arrangement of an HDMI connector. The figure illustrates an example of a pin arrangement for Type-A. Two lines that are differential lines through which TMDS data #i+ and TMDS data #i− corresponding to a differential signal of a TMDS channel #i are respectively transmitted, are respectively connected to a pin that is assigned the TMDS data #i+ (pins having pin numbers 1, 4, and 7) and to a pin that is assigned the TMDS data #i− (pins having pin numbers 3, 6, and 9).

Further, the CEC line 84 by which a CEC signal that corresponds to control data is carried is connected to a pin having a pin number 13, and a pin having a pin number 14 is a reserved pin. Furthermore, a line by which a signal of serial data (SDA) such as E-EDID is carried is connected to a pin having a pin number 16, and a line by which a serial clock (SCL) signal that is a clock signal used to perform synchronization upon transmitting and receiving an SDA signal is carried is connected to a pin having a pin number 15. The DDC 83 described above includes a line by which an SDA signal is carried and a line by which an SCL signal is carried.

Further, the HPD line 86 used by a source device to detect a connection with a sync device, as described above, is connected to a pin having a pin number 19. Furthermore, the power supply line 87 used to supply power, as described above, is connected to a pin having a pin number 18.

“Example of Configuration of High-Speed Bus Interface”

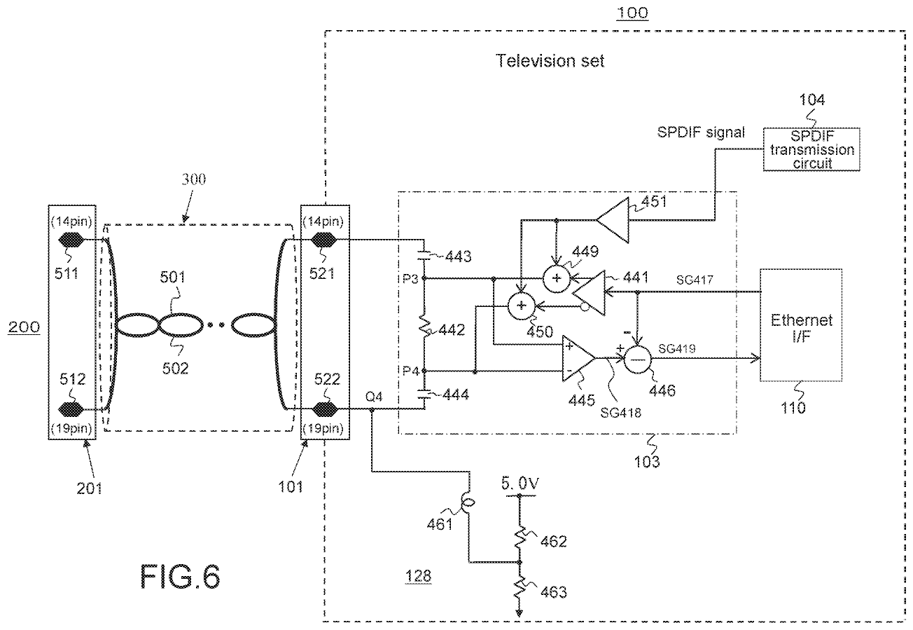

FIG. 6 illustrates an example of a configuration of the high-speed bus interface 103 of the television set 100 in the AV system 10 of FIG. 1. The Ethernet interface 110 performs a local-area-network (LAN) communication, that is, transmission and reception of an Ethernet signal, using a transmission line that includes a pair of a reserve line and an HPD line from among a plurality of lines included in the HDMI cable 300. The SPDIF transmission circuit 104 transmits an SPDIF signal using the transmission line including the pair of lines described above.

The television set 100 includes a LAN signal transmitting circuit 441, a terminator 442, AC coupling capacitors 443 and 444, a LAN signal receiving circuit 445, a subtraction circuit 446, adder circuits 449 and 450, and an amplifier 451. Those components are included in the high-speed bus interface 103. Further, the television set 100 includes a choke coil 461, a resistor 462, and a resistor 463 that are included in a plug-connection transmission circuit 128.

A series circuit of the AC coupling capacitor 443, the terminator 442, and the AC coupling capacitor 444 is connected between a 14-pin terminal 521 and a 19-pin terminal 522 of the HDMI terminal 101. Further, a series circuit of the resistor 462 and the resistor 463 is connected between a power supply line (+5.0 V) and a ground line. Furthermore, a connection point to which the resistor 462 and the resistor 463 are each connected, is connected to a connection point Q4 through the choke coil 461, the connection point Q4 being a connection point to which the 19-pin terminal 522 and the AC coupling capacitor 444 are each connected.

A connection point P3 to which the AC coupling capacitor 443 and the terminator 442 are each connected, is connected to an output side of the adder circuit 449, and is connected to a positive input side of the LAN signal receiving circuit 445. Further, a connection point P4 to which the AC coupling capacitor 444 and the terminator 442 are each connected, is connected to an output side of the adder circuit 450, and is connected to a negative input side of the LAN signal receiving circuit 445.

One of input sides of the adder circuit 449 is connected to a positive output side of the LAN signal transmitting circuit 441, and an SPDIF signal output from the SPDIF transmission circuit 104 is supplied to another of the input sides of the adder circuit 449 through the amplifier 451. Further, one of input sides of the adder circuit 450 is connected to a negative output side of the LAN signal transmitting circuit 441, and the SPDIF signal output from the SPDIF transmission circuit 104 is supplied to another of the input sides of the adder circuit 450 through the amplifier 451.

A transmission signal (transmission data) SG417 is supplied to an input side of the LAN signal transmitting circuit 441 from the Ethernet interface 110. Further, an output signal SG418 of the LAN signal receiving circuit 445 is supplied to a positive terminal of the subtraction circuit 446, and the transmission signal SG417 is supplied to a negative terminal of the subtraction circuit 446. In the subtraction circuit 446, the transmission signal SG417 is subtracted from the output signal SG418 of the LAN signal receiving circuit 445 to obtain a reception signal (reception data) SG419. When a LAN signal (an Ethernet signal) is carried by a reserve line and an HPD line as a differential signal, the reception signal SG419 is the carried LAN signal. The reception signal SG419 is supplied to the Ethernet interface 110.

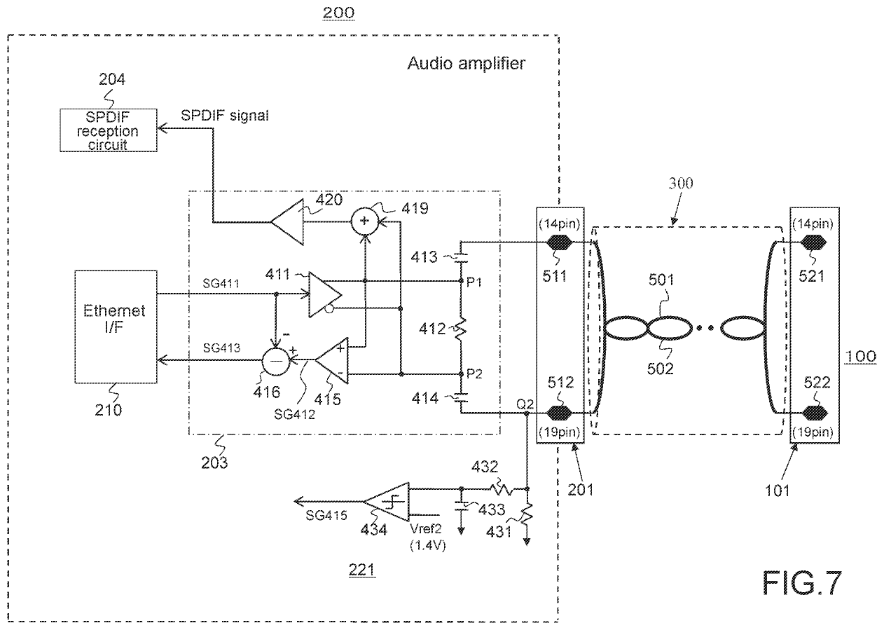

FIG. 7 illustrates an example of a configuration of the high-speed bus interface 203 of the audio amplifier 200 in the AV system 10 of FIG. 1. The Ethernet interface 210 performs a local-area-network (LAN) communication, that is, transmission and reception of an Ethernet signal, using a transmission line that includes a pair of a reserve line and an HPD line from among a plurality of lines included in the HDMI cable 610. The SPDIF reception circuit 204 receives an SPDIF signal using the transmission line including the pair of lines described above.

The audio amplifier 200 includes a LAN signal transmitting circuit 411, a terminator 412, AC coupling capacitors 413 and 414, a LAN signal receiving circuit 415, a subtraction circuit 416, an adder circuit 419, and an amplifier 420. Those components are included in the high-speed bus interface 203. Further, the audio amplifier 200 includes a pull-down resistor 431, a resistor 432, a capacitor 433 and a comparator 434 that are included in a plug-connection detection circuit 221. Here, the resistor 432 and the capacitor 433 are included in a low-pass filter.

A series circuit of the AC coupling capacitor 413, the terminator 412, and the AC coupling capacitor 414 is connected between a 14-pin terminal 511 and a 19-pin terminal 512 of the HDMI terminal 201. A connection point P1 to which the AC coupling capacitor 413 and the terminator 412 are each connected, is connected to a positive output side of the LAN signal transmitting circuit 411, and is connected to a positive input side of the LAN signal receiving circuit 415.

A connection point P2 to which the AC coupling capacitor 414 and the terminator 412 are each connected, is connected to a negative output side of the LAN signal transmitting circuit 411, and is connected to a negative input side of the LAN signal receiving circuit 415. A transmission signal (transmission data) SG411 is supplied to an input side of the LAN signal transmitting circuit 411 from the Ethernet interface 210.

An output signal SG412 of the LAN signal receiving circuit 415 is supplied to a positive terminal of the subtraction circuit 416, and the transmission signal (transmission data) SG411 is supplied to a negative terminal of the subtraction circuit 416. In the subtraction circuit 416, the transmission signal SG411 is subtracted from the output signal SG412 of the LAN signal receiving circuit 415 to obtain a reception signal SG413. When a LAN signal (an Ethernet signal) is carried by a reserve line and an HPD line as a differential signal, the reception signal SG413 is the carried LAN signal. The reception signal SG413 is supplied to the Ethernet interface 210.

A connection point Q2 to which the AC coupling capacitor 414 and the 19-pin terminal 512 are each connected, is connected to a ground line through the pull-down resistor 431, and is connected to the ground line through a series circuit of the resistor 432 and the capacitor 433. Further, an output signal of a low-pass filter is supplied to one of input terminals of the comparator 434, the output signal of the low-pass filter being obtained at a connection point to which the resistor 432 and the capacitor 433 are each connected. In the comparator 434, the output signal of the low-pass filter is compared with a reference voltage Vref2 (+1.4 V) that is supplied to another of the input terminals of the comparator 434. An output-signal SG415 of the comparator 434 is supplied to a control section (CPU) (not illustrated) of the audio amplifier 200.

Further, the connection point P1 to which the AC coupling capacitor 413 and the terminator 412 are each connected, is connected to one of input terminals of the adder circuit 419. Furthermore, the connection point P2 to which the AC coupling capacitor 414 and the terminator 412 are each connected, is connected to another of the input terminals of the adder circuit 419. An output signal of the adder circuit 419 is supplied to the SPDIF reception circuit 204 through the amplifier 420. When an SPDIF signal is carried by a reserve line and an HPD line as an in-phase signal, the output signal of the adder circuit 419 is the carried SPDIF signal.

“Details of SPDIF Signal”

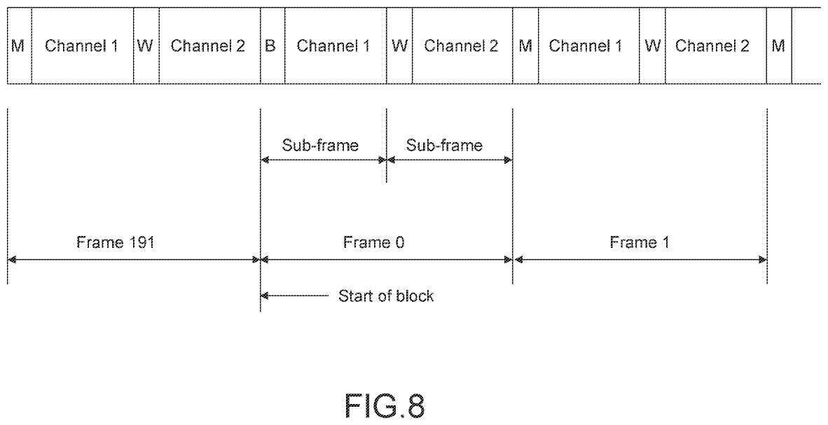

First, an outline of the IEC 60958 standard is described. FIG. 8 illustrates a configuration of a frame in the IEC 60958 standard. Each frame includes two subframes. In the case of 2-channel stereo sound, the first subframe includes a left channel signal, and the second subframe includes a right channel signal.

A preamble is provided at the beginning of a subframe, which will be described later. “M” indicating a preamble is given to a left channel signal, and “W” indicating a preamble is given to a right channel signal. Note that “B” indicating a start of a block is given to a preamble at the beginning once every 192 frames. In other words, a block includes 192 frames. A channel status described later is created for each block.

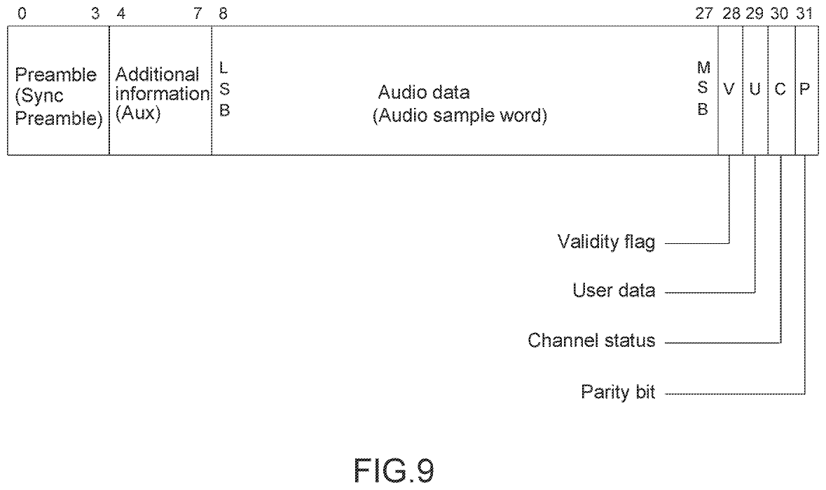

FIG. 9 illustrates a configuration of a subframe in the IEC 60958 standard. The subframe includes 32 time slots in total that are 0th to 31st time slots. The 0th to 3rd time slots correspond to a preamble (sync preamble). As described above, the preamble is represented by one of “M”, “W”, and “B” to distinguish between left and right channels and to indicate a position of a start of a block.

The 4th to 27th time slots correspond to a main data field, and all of the 4th to 27th time slots correspond to audio data when a 24-bit code range is adopted. Further, the 8th to 27th time slots correspond to audio data (audio sample word) when a 20-bit code range is adopted. In the latter case, the 4th to 7th time slots can be used as additional information (auxiliary sample bits). The illustrated example is the latter case.

The 28th time slot corresponds to a validity flag of the main data field. The 29th time slot corresponds to one bit of user data. A series of user data can be constructed by accumulating the 29 time slots of respective frames. A message of the user data is formed for each 8-bit information unit (IU), and a single message includes 3 to 129 information units.

There may be zero to eight bits of “0's” between information units. The beginning of an information unit is identified by a beginning bit of “1”. The first seven information units in a message are reserved, and a user can set any information for the eighth and subsequent information units. Messages are partitioned by eight or more bits of “0's”.

The 30th time slot corresponds to one bit of a channel status. A series of channel statuses can be constructed by accumulating the 30th time slots of respective frames for each block. Note that a position of the beginning of a block is indicated by a preamble (the 0th to the 3rd time slots) represented by “B”, as described above.

The 31st time slot corresponds to parity bits. The parity bits are added such that the sum of “0's” and “1's” included in the 4th to 31st time slots is even.

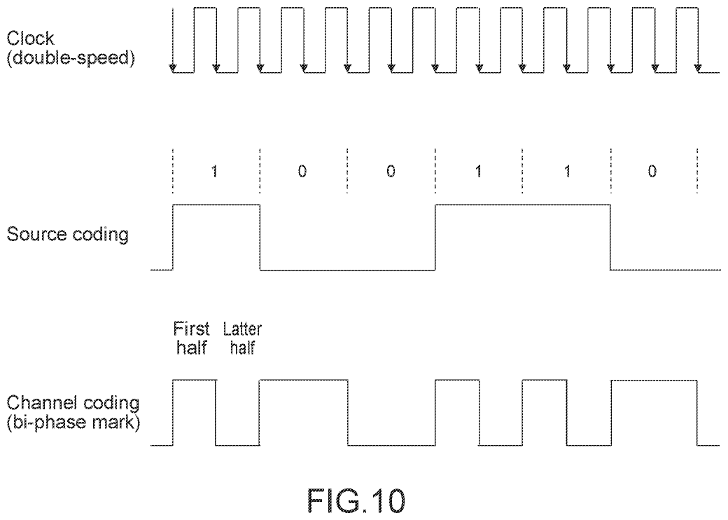

FIG. 10 illustrates a signal modulation scheme in the IEC 60958 standard. A bi-phase-mark modulation is performed on the 4th to 31st time slots obtained by excluding a preamble from a subframe. A clock at twice the rate of an original signal (source coding) is used upon performing the bi-phase-mark modulation. When the clock cycle of an original signal is split into a first half and a latter half, output upon performing a bi-phase-mark modulation is inverted at an edge of a first-half clock cycle without exception. Further, at an edge of a latter-half clock cycle, the output is inverted when the original signal indicates “1”, and the output is not inverted when the original signal indicates “0”. This makes it possible to extract a clock component of an original signal from a signal on which the bi-phase-mark modulation has been performed.

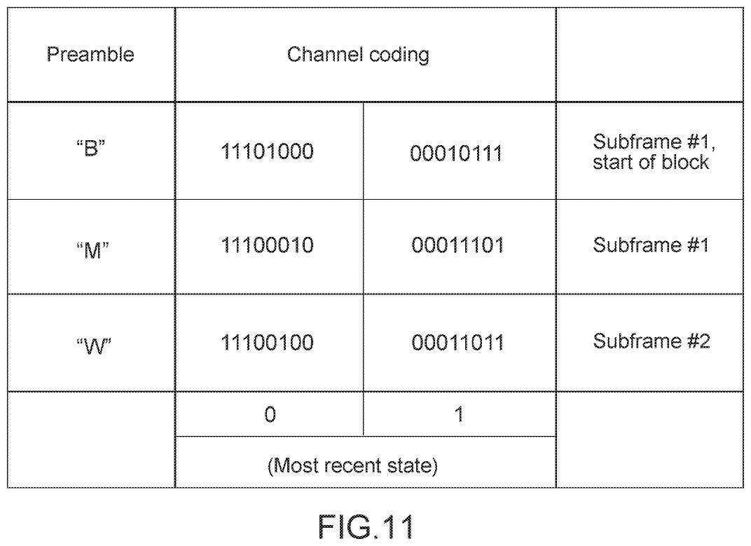

FIG. 11 illustrates channel coding of a preamble in the IEC 60958 standard. As described above, a bi-phase-mark modulation is performed on the 4th to 31st time slots from among a subframe. On the other hand, a normal bi-phase-mark modulation is not performed on a preamble of the 0th to 3rd time slots, and the preamble of the 0th to 3rd time slots is treated in the form of a bit pattern synchronized with a double-speed clock. In other words, two bits are assigned to each of the 0th to 3rd time slots to obtain an 8-bit pattern illustrated in the figure.

When a most recent state is “0”, “11101000” is assigned to the preamble “B”, “11100010” is assigned to the preamble “M”, and “1100100” is assigned to the preamble “W”. On the other hand, when the most recent state is “1”, “00010111” is assigned to the preamble “B”, “00011101” is assigned to the preamble “M”, and “00011011” is assigned to the preamble “W”.

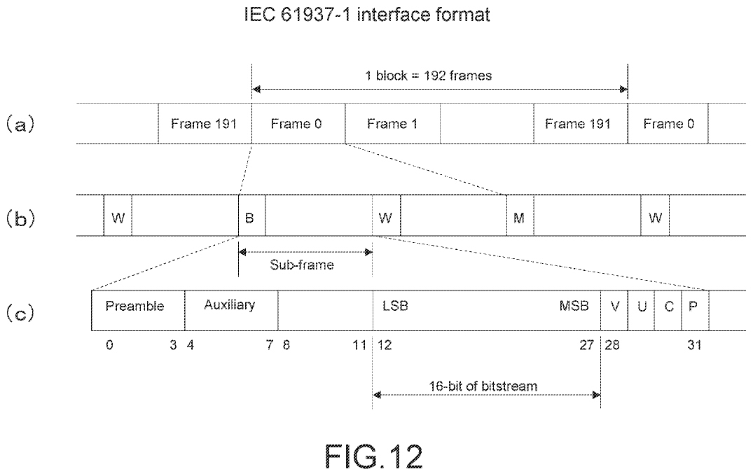

A format used to transmit a compressed audio signal over a protocol compliant with the IEC 60958 standard is defined in the IEC 61937-1 standard. FIG. 12 illustrates an IEC 61937-1 interface format. (a) of FIG. 12 illustrates a configuration of a frame. A single block includes 192 frames, and the format includes a series of the blocks. (b) of FIG. 12 indicates that each frame includes two subframes.

A preamble is provided at the beginning of a subframe, and “B” indicating a start of a block is given to a preamble of a subframe at the beginning of a block. Further, “W” and “M” are alternately given to preambles each situated at the beginning of a subsequent subframe.

(c) of FIG. 12 illustrates a configuration of a subframe. In the case of an SPDIF signal that includes a compressed audio signal of a specified number of channels, a bit stream of a compressed audio signal is split, and bit streams obtained by the split are sequentially inserted into the 12th to 27th time slots of each subframe. In other words, from among a 24-bit audio data region of the 4th to 27th time slots of each subframe, upper 16 bits are used to transmit a compressed audio signal.

In the present embodiment, a compressed audio signal and a linear PCM signal are simultaneously transmitted. As described above, the first method and the second method are conceivable methods for simultaneously transmitting a compressed audio signal and a linear PCM signal.

The first method is described in detail. In this case, an audio signal that is continuous for each subframe is obtained by alternately arranging an audio signal for each subframe that includes a compressed audio signal, and an audio signal for each subframe that includes a linear PCM signal.

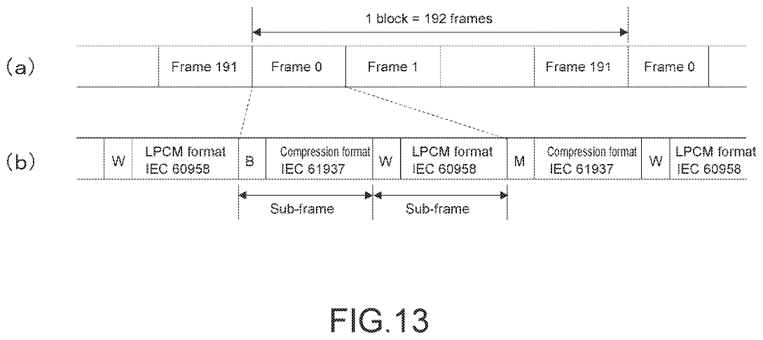

FIG. 13 illustrates an interface format when the first method is adopted. (a) of FIG. 13 illustrates a configuration of a frame. A single block includes 192 frames, and the format includes a series of the blocks. (b) of FIG. 13 indicates that each frame includes two subframes. An odd subframe stores therein a compressed audio format compliant with the IEC 61937-1 standard, and an even subframe stores therein an audio signal in a linear PCM format compliant with the IEC 60958 standard.

Note that an odd subframe may store therein an audio signal in a linear PCM format, and an even subframe may store therein a compressed audio format, but the positional relationship is determined in advance.

As described above, identification information indicating a configuration of an audio signal (an audio signal that is continuous for each subframe is obtained by alternately arranging an audio signal for each subframe that includes a compressed audio signal, and an audio signal for each subframe that includes a linear PCM signal), and configuration information indicating a configuration of the linear PCM signal are added to an audio signal transmitted from the SPDIF transmission circuit 104. In the present embodiment, the pieces of information are added using a channel status bit.

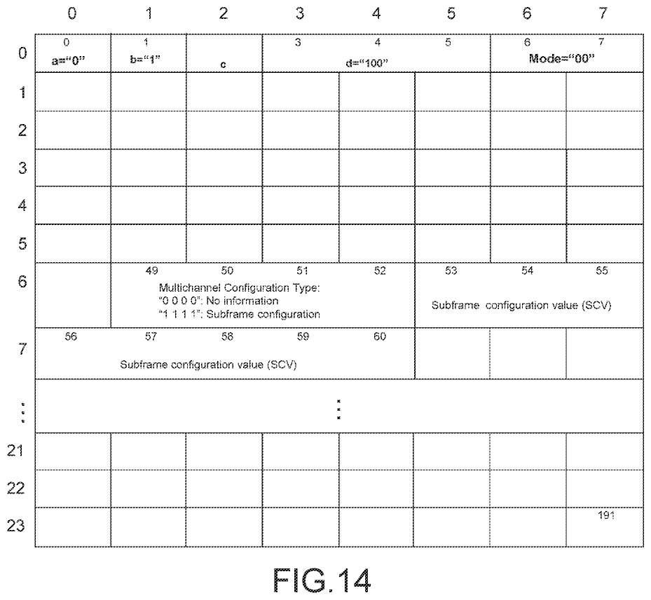

FIG. 14 schematically illustrates a format of a channel status when the first method is adopted. The entirety of a channel status includes 0th to 23rd bytes. a=“0” of a 0th bit indicates that the channel status is for consumer use. Further, b=“1” of a 1st bit indicates the use for transmission of a compressed audio signal, as in the case of the IEC 61937-1 interface format.

Note that, with respect to three bits of 3rd to 5th bits, “000” is assigned in the conventional IEC 61937-1 interface format, and an operation is satisfactorily performed with the same application as the conventional IEC 61937-1 interface format. However, a different value may be assigned to distinguish the format from the conventional IEC 61937-1 interface format. “100” is assigned in the illustrated example.

With respect to four bits of 49th to 52nd bits, “0000” is assigned in the conventional IEC 61937-1 interface format. However, a value different from that of the conventional IEC 61937-1 interface format is assigned, and the value represents identification information (a subframe configuration) indicating a configuration of an audio signal. Here, for example, “1111” is assigned, which indicates that an audio signal that is continuous for each subframe is obtained by alternately arranging an audio signal for each subframe that includes a compressed audio signal, and an audio signal for each subframe that includes a linear PCM signal.

Further, when “1111” is assigned to the four bits of 49th to 52nd bits, as described above, subsequent eight bits of 53rd to 60th bits are valid. The eight bits represent configuration information indicating a configuration of a linear PCM signal.

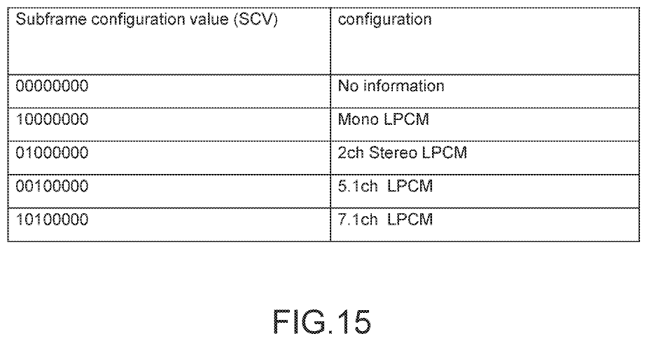

FIG. 15 illustrates an example of a correspondence relationship between a value “Subframe configuration value” of the eight bits of the 53rd to 60th bits, and a configuration “Configuration” of a linear PCM signal. For example, “10000000” represents “mono LPCM”, “01000000” represents “2-channel stereo LPCM”, “00100000” represents “5.1-channel LPCM”, and “10100000” represents “7.1-channel LPCM”.

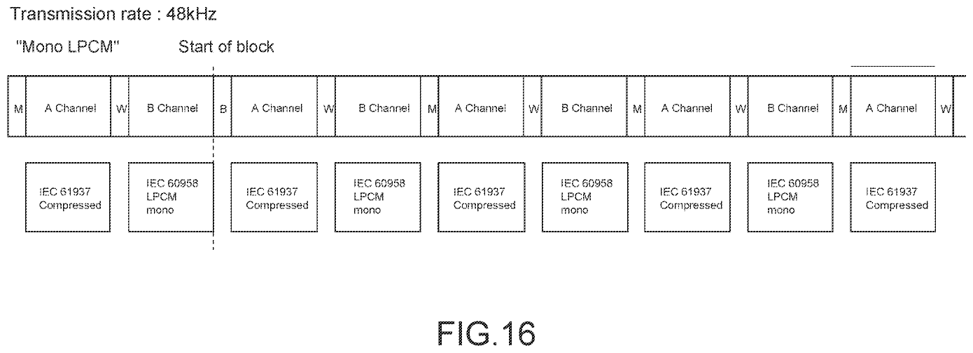

FIG. 16 illustrates an example of a configuration of a frame when the entirety of a stream is transmitted at 48 kHz and when a linear PCM signal has a configuration of “mono LPCM”. In this case, an odd subframe includes a compressed audio signal, and an even subframe includes a mono linear PCM signal. Note that a 48-kHz linear PCM signal is transmitted over one channel at the maximum when the entirety of a stream is transmitted at 48 kHz, as described above. Thus, if two or more channels are specified by the SCV, this will be invalid.

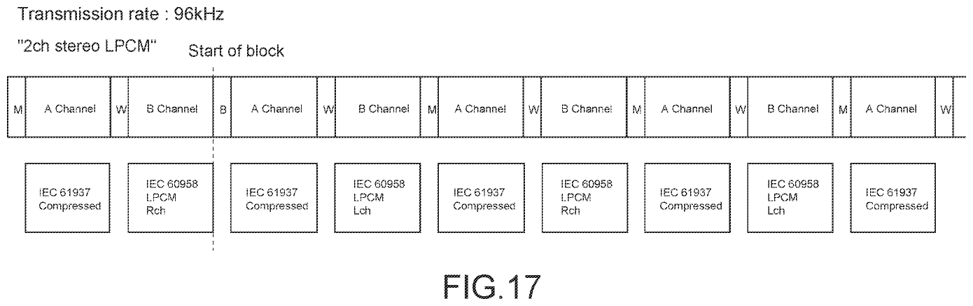

FIG. 17 illustrates an example of a configuration of a frame when the entirety of a stream is transmitted at 96 kHz and when a linear PCM signal has a configuration of “2-channel stereo LPCM”. A 48-kHz linear PCM signal is transmitted over two channels when the entirety of a stream is transmitted at 48 kHz. In this case, a transmission over a first channel (normally an L channel) is performed in a W preamble next to a B preamble at the beginning of a block, and a transmission over a second channel (normally an R channel) is performed in a W preamble next to an M preamble subsequent to the W preamble next to the B preamble. Thereafter, the transmission over the first channel and the transmission over the second channel are alternately performed.

Likewise, an increase in a transmission rate of the entirety of a stream makes it possible to transmit, for example, the “5.1 channel LPCM” and the “7.1 channel LPCM”.

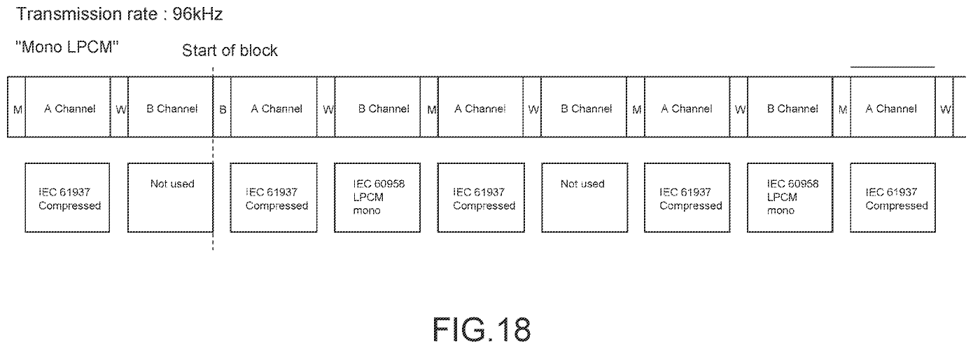

Note that the insertion of an invalid subframe makes it possible to reduce a sampling frequency of a portion corresponding to a linear PCM signal. FIG. 18 illustrates an example of a configuration of a frame when the entirety of a stream is transmitted at 96 kHz and when a linear PCM signal has a configuration of “mono LPCM”. In this case, every fourth subframe is an invalid subframe. When the transmission rate is 96 kHz and “mono LPCM” is specified by the SCV, the linear PCM signal has the frame configuration illustrated in the figure.

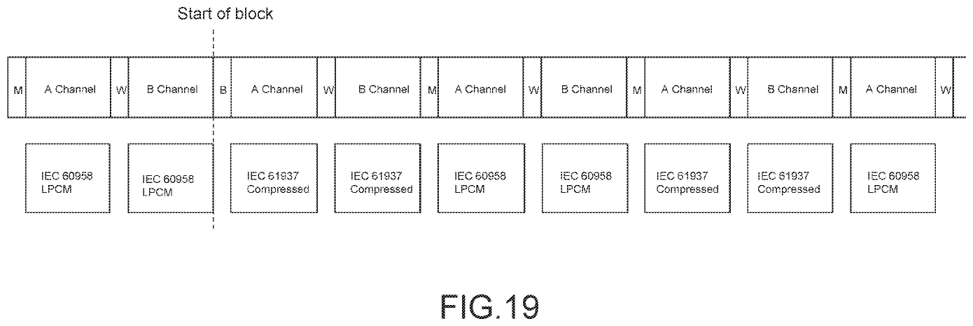

The example in which a compressed audio signal and a linear PCM signal are alternately arranged for each subframe has been described above. However, a configuration in which a compressed audio signal and a linear PCM signal are alternately arranged for each frame may also be adopted. FIG. 19 illustrates an example of a configuration of a frame in such a case. In this case, a compressed audio signal is transmitted in a B preamble at the beginning of a block and in a W preamble next to the B preamble, and a linear PCM signal is transmitted in an M preamble subsequent to the W preamble next to the B preamble and in a W preamble next to the M preamble. Thereafter, the processing described above is repeated.

Next, the second method is described in detail. In this case, an audio signal for each subframe is a mixture signal of a compressed audio signal and a linear PCM signal.

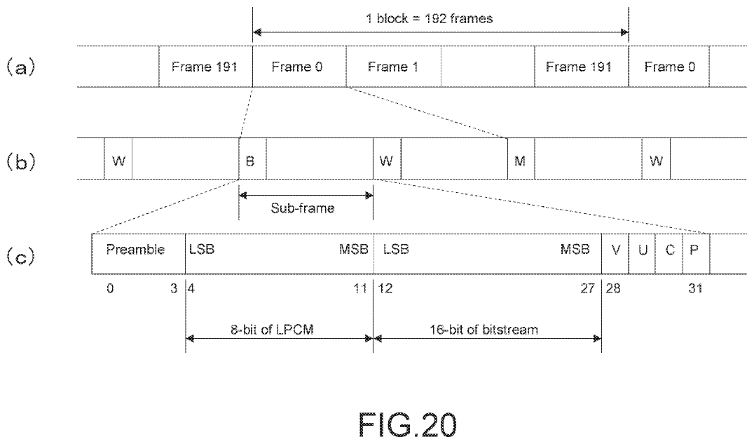

FIG. 20 illustrates an interface format when a compressed audio signal and a linear PCM signal are simultaneously transmitted. (a) and (b) of FIG. 20 are respectively similar to (a) and (b) of FIG. 12. (c) of FIG. 13 illustrates a configuration of a subframe. From among a 24-bit audio data region of the 4th to 27th time slots of each subframe, upper 16 bits are used to transmit a compressed audio signal, and lower 8 bits are used to transmit a linear PCM signal.

As described above, identification information indicating a configuration of an audio signal (an audio signal for each subframe is a mixture signal of a compressed audio signal and a linear PCM signal), and configuration information indicating a configuration of the linear PCM signal are added to an audio signal transmitted from the SPDIF transmission circuit 104. In the present embodiment, the pieces of information are added using a channel status bit.

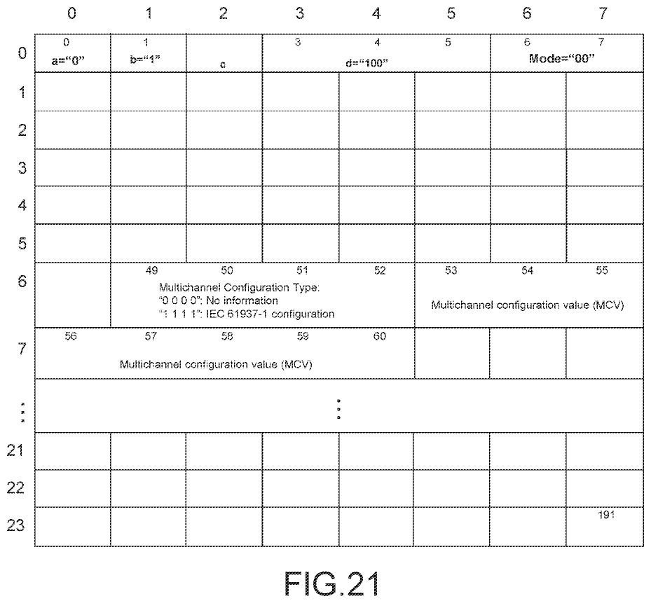

FIG. 21 schematically illustrates a format of a channel status when a compressed audio signal and a linear PCM signal are simultaneously transmitted. The entirety of a channel status includes 0th to 23rd bytes. a=“0” of a 0th bit indicates that the channel status is for consumer use. Further, b=“1” of a 1st bit indicates the use for transmission of a compressed digital audio signal, as in the case of the IEC 61937-1 interface format.

Note that, with respect to three bits of 3rd to 5th bits, “000” is assigned in the conventional IEC 61937-1 interface format, and an operation is satisfactorily performed with the same application as the conventional IEC 61937-1 interface format. However, a different value may be assigned to distinguish the format from the conventional IEC 61937-1 interface format. “100” is assigned in the illustrated example.

With respect to four bits of 49th to 52nd bits, “0000” is assigned in the conventional IEC 61937-1 interface format. However, a value different from that of the conventional IEC 61937-1 interface format is assigned, and the value represents identification information indicating that an audio signal for each subframe is a mixture signal of a compressed audio signal and a linear PCM signal. “1111” is assigned in the illustrated example. Further, the value of the four bits of 49th to 52nd bits indicates that an audio signal for each subframe is a mixture signal, subsequent eight bits of 53rd to 60th bits are valid.

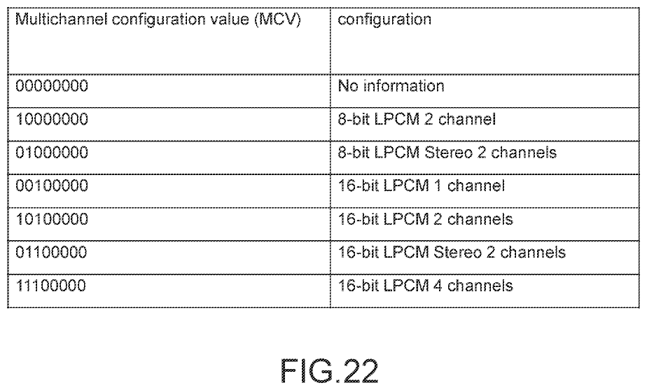

The eight bits represent configuration information indicating a configuration of a linear PCM signal. FIG. 22 illustrates an example of a correspondence relationship between a value “Multichannel configuration value” of the eight bits of the 53rd to 60th bits, and a configuration of a linear PCM signal. For example, “10000000” represents a configuration of “8-bit LPCM 2 channel”, that is, an 8-bit two-channel configuration. Further, for example, “01000000” represents a configuration of “8-bit LPCM Stereo 2 channel”, that is, an 8-bit two-channel stereo configuration.

Furthermore, for example, “00100000” represents a configuration of “16-bit LPCM 1 channel”, that is, a 16-bit single-channel configuration. Moreover, for example, “10100000” represents a configuration of “16-bit LPCM 2 channel”, that is, a 16-bit two-channel configuration. Further, for example, “01100000” represents a configuration of “16-bit LPCM Stereo 2 channel”, that is, a 16-bit two-channel stereo configuration. Furthermore, for example, “11100000” represents a configuration of “16-bit LPCM 4 channel”, that is, a 16-bit four-channel configuration.

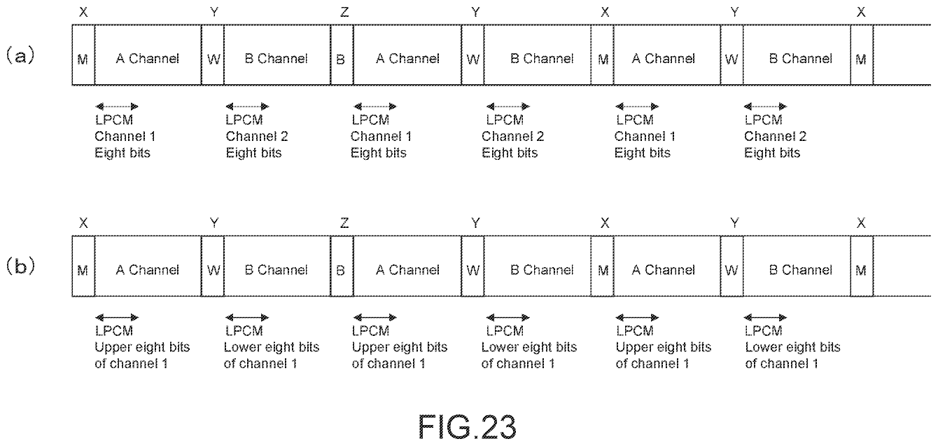

(a) of FIG. 23 illustrates an example of a configuration of a frame in the case of the 8-bit two-channel configuration. In this case, a linear PCM signal of eight bits of a channel 1 is assigned to lower eight bits of an A channel, and a linear PCM signal of eight bits of a channel 2 is assigned to lower eight bits of a B channel.

(b) of FIG. 23 illustrates an example of a configuration of a frame in the case of the 16-bit single-channel configuration. In this case, a linear PCM signal of upper eight bits of a channel 1 is assigned to lower eight bits of an A channel, and a linear PCM signal of lower eight bits of the channel 1 is assigned to lower eight bits of a B channel.

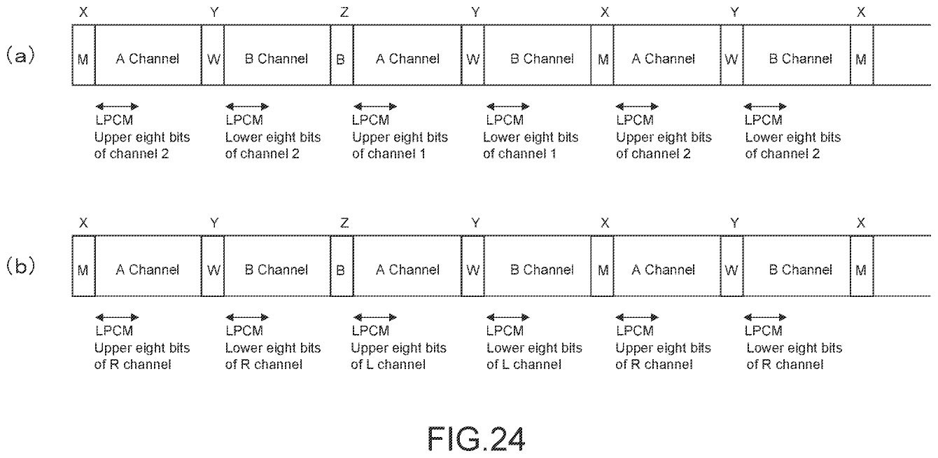

(a) of FIG. 24 illustrates an example of a configuration of a frame in the case of the 16-bit two-channel configuration. When a transmission rate is doubled, that is, when, for example, an original sampling frequency is 48 kHz and the transmission rate is 96 kHz, the sampling frequency of a linear PCM signal is not changed to 96 kHz, and remains at 48 kHz.

In this case, a linear PCM signal of upper eight bits of a channel 1 is assigned to lower eight bits of an odd A channel counting from the beginning of a block, and a linear PCM signal of lower eight bits of the channel 1 is assigned to lower eight bits of an odd B channel counting from the beginning of the block. A linear PCM signal of upper eight bits of a channel 2 is assigned to lower eight bits of an even A channel counting from the beginning of the block, and a linear PCM signal of lower eight bits of the channel 2 is assigned to lower eight bits of an even B channel counting from the beginning of the block.

(b) of FIG. 24 illustrates an example of a configuration of a frame in the case of the 16-bit two-channel stereo configuration. When a transmission rate is doubled, that is, when, for example, an original sampling frequency is 48 kHz and the transmission rate is 96 kHz, the sampling frequency of a linear PCM signal is not changed to 96 kHz, and remains at 48 kHz.

In this case, a linear PCM signal of upper eight bits of an L channel is assigned to lower eight bits of an odd A channel counting from the beginning of a block, and a linear PCM signal of lower eight bits of the L channel is assigned to lower eight bits of an odd B channel counting from the beginning of the block. A linear PCM signal of upper eight bits of an R channel is assigned to lower eight bits of an even A channel counting from the beginning of the block, and a linear PCM signal of lower eight bits of the R channel is assigned to lower eight bits of an even B channel counting from the beginning of the block.

Further, a transmission rate is increased by a factor of four and a 4-channel linear PCM signal is assigned when the configuration of a frame is the 16-bit four-channel configuration, although an illustration thereof is omitted. Likewise, the number of channels can be increased, the number of bits can be set to 32 bits, and, further, a linear PCM signal of, for example, 5.1 channels can be transmitted. Detailed descriptions thereof are omitted.

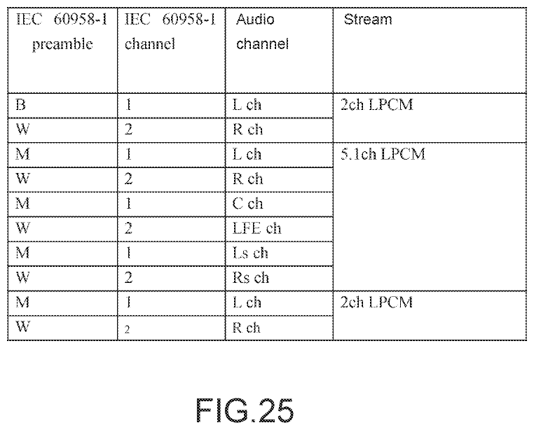

FIG. 25 illustrates an example of a configuration of a frame when a two-channel stereo linear PCM signal and a 5.1-channel linear PCM signal are transmitted. In this case, a two-channel stereo linear PCM signal is assigned to the first pair of an A channel and a B channel counting from the beginning of a block, and a 5.1-channel linear PCM signal is assigned to subsequent three pairs of the A channel and the B channel. Thereafter, the processing described above is repeated.

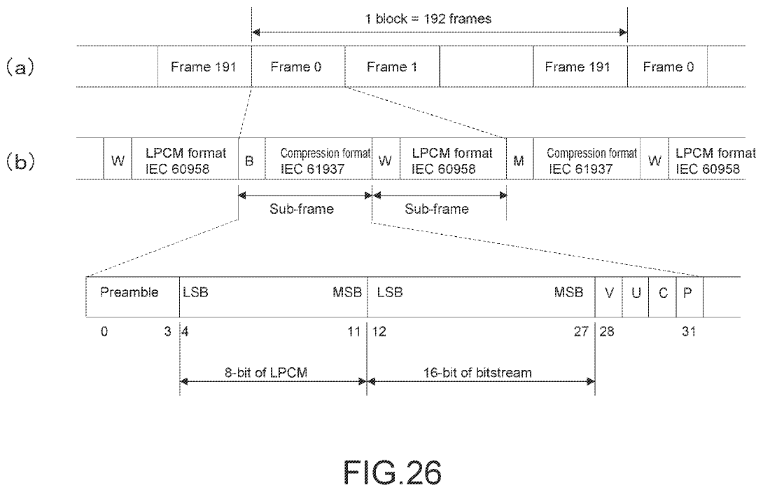

Note that the first method and the second method described above may be used in combination to increase the number of channels over which a linear PCM signal can be transmitted. FIG. 26 illustrates an interface format when the first method and the second method are used in combination. (a) of FIG. 26 illustrates a configuration of a frame. A single block includes 192 frames, and the format includes a series of the blocks.

(b) of FIG. 26 indicates that each frame includes two subframes. An odd subframe stores therein a compressed audio format compliant with the IEC 61937-1 standard, and an even subframe stores therein an audio signal in a linear PCM format compliant with the IEC 60958 standard.

Further, from among a 24-bit audio data region of 4th to 27th time slots of an odd subframe storing therein the compressed audio format, upper 16 bits are used to transmit a compressed audio signal, and lower 8 bits are used to transmit a linear PCM signal.

Further, various information related to a linear PCM signal is added to an audio signal transmitted from the SPDIF transmission circuit 104, as described above. In the present embodiment, the information is added using a user bit.

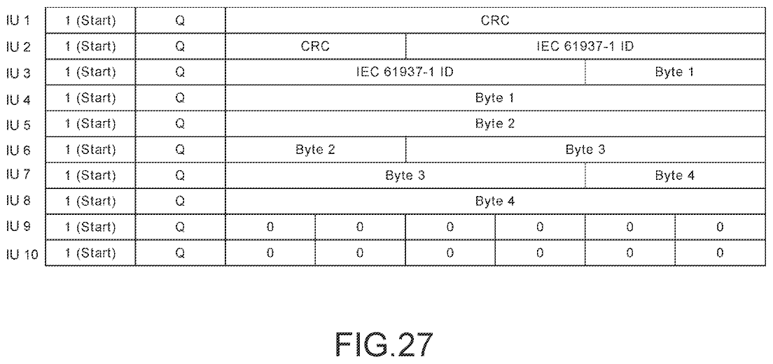

FIG. 27 illustrates an example of a user data message. The user data message includes ten information units (IUs). Information regarding “IEC 61937-1 ID”, that is, identification information indicating the type of information is arranged in 4th to 0th bits of a second IU and in 5th to 2nd bits of a third IU. Further, a four-byte information field is provided in 1st to 0th bits of the 3rd IU and in 5th to 0th bits of fourth to eighth IUs. Note that the number of bytes for the information field is not limited to four.

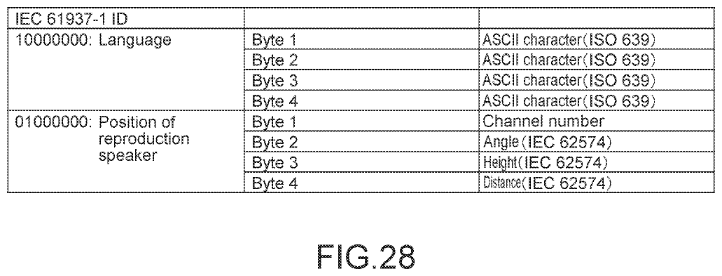

FIG. 28 illustrates an example of information. For example, when “IEC 61937-1 ID” is “10000000”, it indicates language information regarding sound provided by a linear PCM signal. In this case, ASCII-character information indicating an abbreviation of a language name is arranged in a four-byte information field. Further, for example, when “IEC 61937-1 ID” is “01000000”, it indicates information regarding a position of a speaker that reproduces sound provided by a linear PCM signal. In this case, information indicating a channel number, an angle, a height, and a distance is arranged in the four-byte information field. Note that the illustrated information is merely an example, and the information is not limited thereto. The use of the user data message illustrated in FIG. 27 makes it possible to transmit various information related to a linear PCM signal to the reception side.

As described above, in the AV system 10 illustrated in FIG. 1, the television set 100 can successfully simultaneously transmit a compressed audio signal and a linear PCM signal to the audio amplifier 200, and, further, the audio player 200 can successfully simultaneously reproduce the compressed audio signal and the linear PCM signal.

Further, for example, the following processing can be performed in the AV system 10 illustrated in FIG. 1 when enjoying 5.1-channel surround sound using the audio amplifier 200 while viewing an image of broadcast content using the television set 100. (1) A notification sound used to notify that an e-mail has been received can be reproduced. (2) A sound of an operation performed on the user interface 106 can be reproduced. (3) Sound obtained by performing conversion on subtitle data can be reproduced. (4) Switching of a language of sound reproduced by the audio amplifier 200 can be performed, and a language name can be displayed on the display section 209 of the audio amplifier 200. (5) Sound provided by a linear PCM signal can be reproduced, and a position to localize the reproduced sound can be changed on the basis of speaker-position information.

Note that the effects described herein are not limitative but are merely illustrative, and additional effects may be provided.

### 2. Modifications

Note that, in the embodiments described above, the language can be switched by a user performing an operation using the audio amplifier 200 when sound provided by a compressed audio signal is a first language and sound provided by a linear PCM signal is a second language. However, the switching operation may be performed using the television set 100.

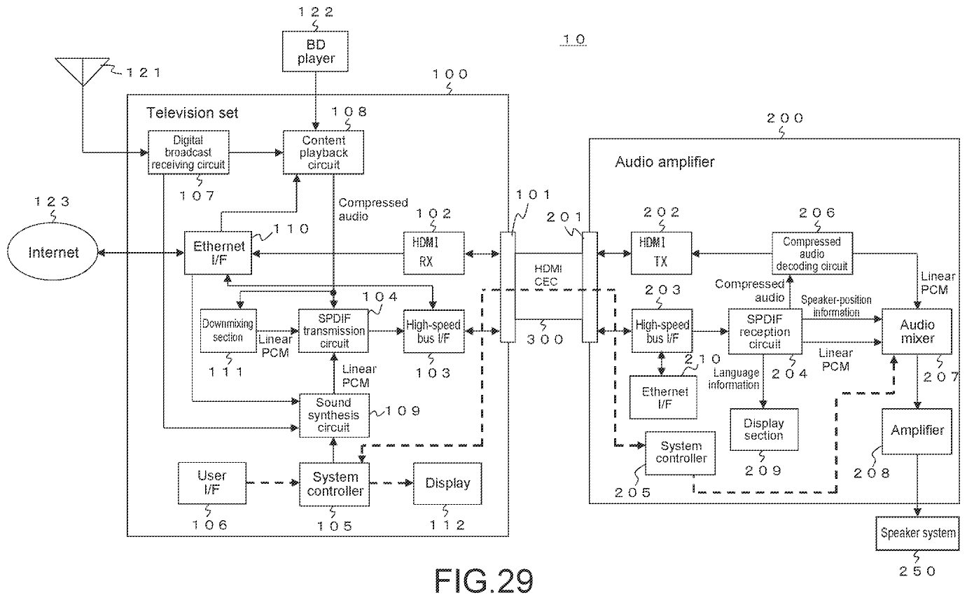

FIG. 29 is a diagram for describing an operation performed in this case, where a route related to this operation is indicated by a dashed line. In FIG. 29, a portion corresponding to a portion of FIG. 1 is denoted by the same reference numeral as the portion of FIG. 1. First, a user performs an operation of switching the sound using the user interface 106 of the television set 100, such as a remote controller. In response to this operation, the system controller 105 of the television set 100 transmits a sound switching command to the system controller 205 of the audio amplifier 200 through the CEC line of the HDMI cable 300.

The system controller 205 of the audio amplifier 200 controls the audio mixer 207 to switch the sound on the basis of the sound switching command, and reports completion of switching the sound to the system controller 105 of the television set 100 through the CEC line of the HDMI cable 300. On the basis of the report, the system controller 105 of the television set 100 displays, on a display 112, a name of a language that is used after the switching is performed.

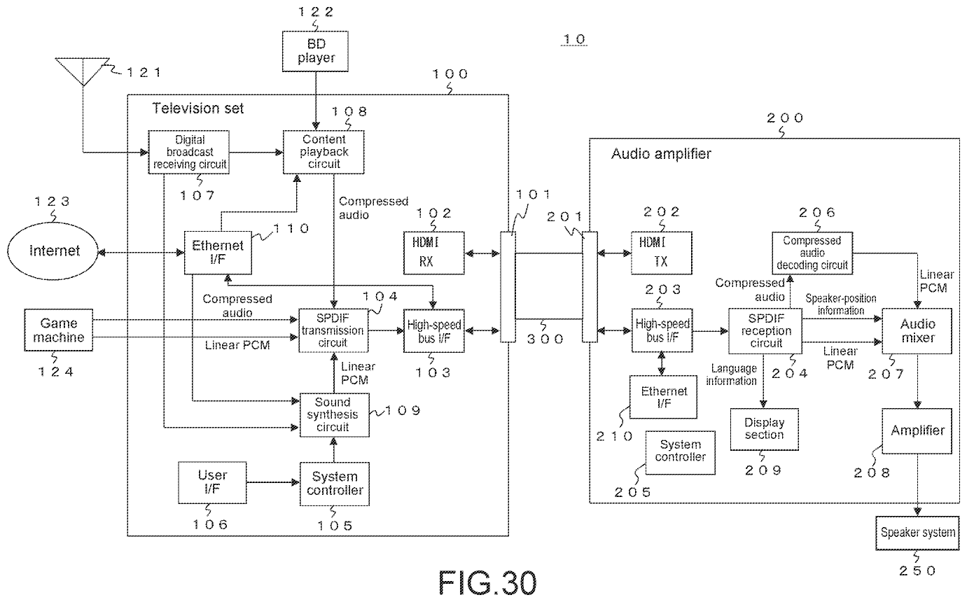

FIG. 30 illustrates an example of a configuration in which a game machine 124 is connected to the television set 100 to play a game. In FIG. 30, a portion corresponding to a portion of FIG. 1 is denoted by the same reference numeral as the portion of FIG. 1. In this case, a compressed audio signal of a sound track, and a linear PCM signal of a real-time response sound given by a game controller are output from the game machine 124. These multichannel compressed audio signal and linear PCM signal are supplied to the SPDIF transmission circuit 104 to be simultaneously transmitted to the audio amplifier 200. The sound track and the real-time response sound are simultaneously reproduced by the audio amplifier 200.

Note that a linear PCM signal for a sound source in which a position to localize sound is changed discretionarily may be output from the game machine 124, the linear PCM signal may be supplied to the SPDIF transmission circuit 104, and the linear PCM signal and a compressed audio signal may be simultaneously transmitted to the audio amplifier 200. In this case, speaker-position information is added as information related to the linear PCM signal, and this results in localization processing being performed in real time in the audio mixer 207 of the audio amplifier 200.

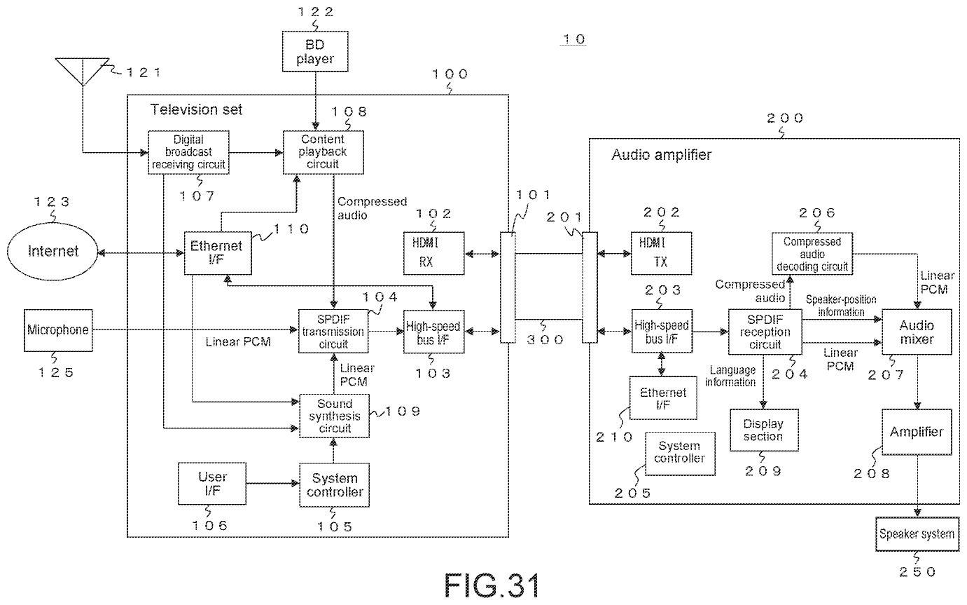

FIG. 31 illustrates an example of a configuration in which a microphone 125 is connected to the television set 100 to sing a karaoke song. In FIG. 31, a portion corresponding to a portion of FIG. 1 is denoted by the same reference numeral as the portion of FIG. 1. In this case, a karaoke compressed audio signal is obtained from, for example, the BD player 122. Further, a linear PCM signal corresponding to singing of a user is obtained from the microphone 125. The karaoke compressed audio signal, and the linear PCM signal from the microphone 125 are supplied to the SPDIF transmission circuit 104 to be simultaneously transmitted to the audio amplifier 200. Sound of a backing track and sound of singing are simultaneously reproduced in the audio amplifier 200.

In this case, the sound of a backing track is provided by a karaoke compressed audio signal, whereas the sound of singing is provided by a linear PCM signal with a level of quality higher than the level of quality of the sound of a backing track. This results in providing an advantage in that the sound of signing sounds better. Further, the sound of signing is transmitted by a linear PCM signal, and thus the latency is lower. This results in being able to sing easily.

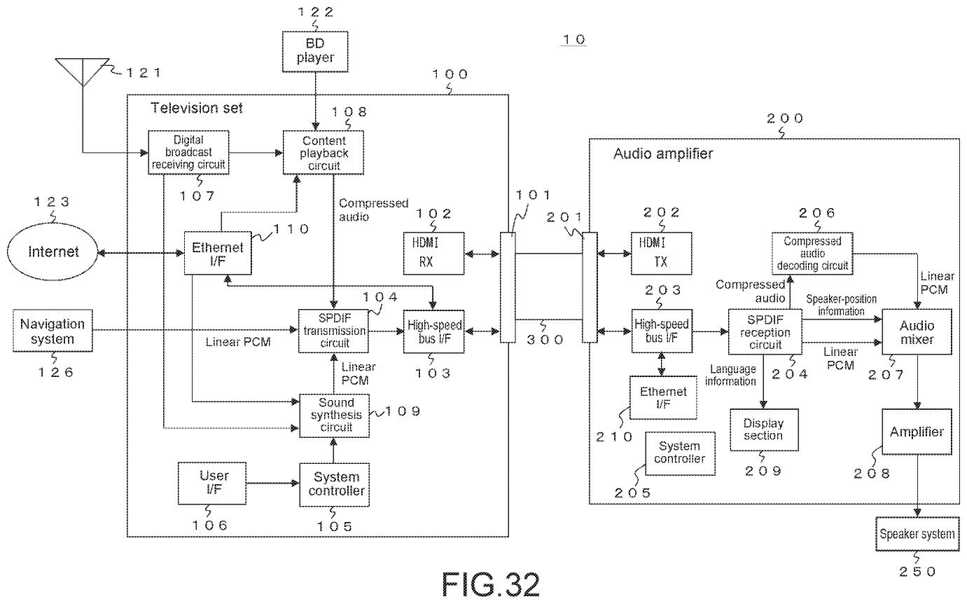

FIG. 32 illustrates an example of a configuration in which a navigation system 126 is used by being connected to the television set 100, which is intended for use in a vehicle. In FIG. 32, a portion corresponding to a portion of FIG. 1 is denoted by the same reference numeral as the portion of FIG. 1. In this case, a linear PCM signal of audio guidance from the navigation system 126 is supplied to the SPDIF transmission circuit 104 to be transmitted to the audio amplifier 200 simultaneously with a compressed audio signal. In the audio amplifier 200, navigation sound is reproduced in a state of being superimposed on reproduced sound of broadcast content or playback content in real time.

Note that, in the VR/AR application, the present technology is also applicable when background sound and synthesized sound that varies in real time are simultaneously transmitted, although a detailed description thereof is omitted. In this case, the background sound is transmitted by a compressed audio signal, and the synthesized sound is transmitted by a linear PCM signal. Further, in the field of healthcare, the present technology is also applicable when a signal used to control a motor in each position of a massage chair is transmitted over a linear PCM channel, while playing multichannel music on the massage chair. The linear PCM enables representation of a DC level, although it is difficult to provide such representation using compression.

The example of using an HDMI ARC as an IEC 60958 transmission line has been described in the embodiments above. However, an example of using a coaxial cable or an optical cable as the IEC 60958 transmission line is also conceivable. Further, an example of using an HDMI transmission line as the IEC 60958 transmission line is also conceivable. In this case, an SPDIF signal (an IEC 60958 signal) is mapped to an audio sample packet to be transmitted in a forward direction that is the same direction as video transmission. Likewise, an example of using, for example, an IEC 61883-6 transmission line, an MHL transmission line, or a DisplayPort transmission line (a DP transmission line) as the IEC 60958 transmission line is also conceivable. In these cases, an SPDIF signal (an IEC 60958 signal) is also mapped to an audio sample packet to be transmitted in a forward direction that is the same direction as video transmission.

Further, the favorable embodiments of the present disclosure have been described above in detail with reference to the accompanying drawings. However, the technical scope of the present disclosure is not limited to these examples. It is clear that persons who have common knowledge in the technical field of the present disclosure could have conceived various alterations or modifications within the scope of a technical idea according to an embodiment of the present disclosure. It is understood that of course such alterations or modifications also fall under the technical scope of the present disclosure.

Furthermore, the technology may also take the following configurations.
(1) A transmission apparatus, including

a transmission section that transmits an audio signal continuous for each specified unit to a reception side through a specified transmission line, the audio signal continuous for each specified unit being obtained by alternately arranging the audio signal in the specified unit, which includes a compressed audio signal, and the audio signal in the specified unit, which includes a linear PCM signal.
(2) The transmission apparatus according to (1), in which

the specified unit is a subframe.
(3) The transmission apparatus according to (1) or (2), in which

the linear PCM signal is an audio signal by which a real-time performance is to be ensured.
(4) The transmission apparatus according to any one of (1) to (3), further including

an information adder that adds, to the audio signal transmitted by the transmission section, identification information indicating that the audio signal transmitted by the transmission section is obtained by alternately arranging the audio signal in the specified unit, which includes a compressed audio signal, and the audio signal in the specified unit, which includes a linear PCM signal.
(5) The transmission apparatus according to any one of (1) to (4), in which

the information adder adds the identification information using a specified bit region in a channel status for each block, the specified bit region being assigned a specified number, the channel status being made up for each specified unit.
(6) The transmission apparatus according to any one of (1) to (5), further including

an information adder that adds, to the audio signal transmitted by the transmission section, configuration information indicating a configuration of the linear PCM signal.
(7) The transmission apparatus according to (6), in which

the information adder adds the configuration information using a specified bit region in a channel status for each block, the specified bit region being assigned a specified number, the channel status being made up for each specified unit.
(8) The transmission apparatus according to any one of (1) to (7), further including

an information adder that adds, to the audio signal transmitted by the transmission section, information related to the linear PCM signal.
(9) The transmission apparatus according to (8), in which

the information adder adds the information related to the linear PCM signal using consecutive user data bits in the specified unit, the consecutive user data bits being assigned a specified number.
(10) The transmission apparatus according to any one of (1) to (9), further including:

a first acquisition section that acquires the compressed audio signal; and

a second acquisition section that acquires the linear PCM signal.
(11) The transmission apparatus according to any one of (1) to (10), in which

the specified transmission line is one of a coaxial cable, an optical cable, an Ethernet (an IEC 61883-6) cable, an HDMI cable, an MHL cable, and a DisplayPort cable.
(12) A transmission method, including

transmitting an audio signal continuous for each specified unit to a reception side through a specified transmission line, the audio signal continuous for each specified unit being obtained by alternately arranging the audio signal in the specified unit, which includes a compressed audio signal, and the audio signal in the specified unit, which includes a linear PCM signal.
(13) A reception apparatus, including

a reception section that receives an audio signal continuous for each specified unit from a transmission side through a specified transmission line, the audio signal continuous for each specified unit being obtained by alternately arranging the audio signal in the specified unit, which includes a compressed audio signal, and the audio signal in the specified unit, which includes a linear PCM signal.
(14) The reception apparatus according to (13), further including

a processor that performs processing on the compressed audio signal and the linear PCM signal to obtain an output linear PCM signal.
(15) The reception apparatus according to (14), in which

configuration information indicating a configuration of the linear PCM signal is added to the audio signal received by the reception section, and

the processor performs processing on the linear PCM signal on the basis of the configuration information.
(16) The reception apparatus according to (14) or (15), in which

information related to the linear PCM signal is added to the audio signal received by the reception section, and

the processor performs processing on the linear PCM signal on the basis of the information related to the linear PCM signal.
(17) A reception method, including

receiving an audio signal continuous for each specified unit from a transmission side through a specified transmission line, the audio signal continuous for each specified unit being obtained by alternately arranging the audio signal in the specified unit, which includes a compressed audio signal, and the audio signal in the specified unit, which includes a linear PCM signal.

### REFERENCE SIGNS LIST

10 AV system
100 television set
101 HDMI terminal
102 HDMI reception section
103 high-speed bus interface
104 SPDIF transmission circuit
105 system controller
106 user interface
107 digital broadcast receiving circuit
108 content playback circuit
109 sound synthesis circuit
110 Ethernet interface
111 downmixing section
112 display
121 reception antenna
122 BD player
123 Internet
124 game machine
125 microphone
126 navigation system
200 audio amplifier
201 HDMI terminal
202 HDMI transmission section
203 high-speed bus interface
204 SPDIF reception circuit
205 system controller
206 compressed audio decoding circuit
207 audio mixer
208 amplifier
209 display section
210 Ethernet interface
250 speaker system
300 HDMI cable

1. A transmission apparatus, comprising
a transmission section that transmits an audio signal continuous for each specified unit to a reception side through a specified transmission line, the audio signal continuous for each specified unit being obtained by alternately arranging the audio signal in the specified unit, which includes a compressed audio signal, and the audio signal in the specified unit, which includes a linear PCM signal.

2. The transmission apparatus according to claim 1, wherein
the specified unit is a subframe.

3. The transmission apparatus according to claim 1, wherein
the linear PCM signal is an audio signal by which a real-time performance is to be ensured.

4. The transmission apparatus according to claim 1, further comprising
an information adder that adds, to the audio signal transmitted by the transmission section, identification information indicating that the audio signal transmitted by the transmission section is obtained by alternately arranging the audio signal in the specified unit, which includes a compressed audio signal, and the audio signal in the specified unit, which includes a linear PCM signal.

5. The transmission apparatus according to claim 4, wherein
the information adder adds the identification information using a specified bit region in a channel status for each block, the specified bit region being assigned a specified number, the channel status being made up for each specified unit.

6. The transmission apparatus according to claim 1, further comprising
an information adder that adds, to the audio signal transmitted by the transmission section, configuration information indicating a configuration of the linear PCM signal.

7. The transmission apparatus according to claim 6, wherein
the information adder adds the configuration information using a specified bit region in a channel status for each block, the specified bit region being assigned a specified number, the channel status being made up for each specified unit.

8. The transmission apparatus according to claim 1, further comprising
an information adder that adds, to the audio signal transmitted by the transmission section, information related to the linear PCM signal.

9. The transmission apparatus according to claim 8, wherein
the information adder adds the information related to the linear PCM signal using consecutive user data bits in the specified unit, the consecutive user data bits being assigned a specified number.

10. The transmission apparatus according to claim 1, further comprising:
a first acquisition section that acquires the compressed audio signal; and
a second acquisition section that acquires the linear PCM signal.

11. The transmission apparatus according to claim 1, wherein
the specified transmission line is one of a coaxial cable, an optical cable, an Ethernet (an IEC 61883-6) cable, an HDMI cable, an MHL cable, and a DisplayPort cable.

12. A transmission method, comprising
transmitting an audio signal continuous for each specified unit to a reception side through a specified transmission line, the audio signal continuous for each specified unit being obtained by alternately arranging the audio signal in the specified unit, which includes a compressed audio signal, and the audio signal in the specified unit, which includes a linear PCM signal.

13. A reception apparatus, comprising
a reception section that receives an audio signal continuous for each specified unit from a transmission side through a specified transmission line, the audio signal continuous for each specified unit being obtained by alternately arranging the audio signal in the specified unit, which includes a compressed audio signal, and the audio signal in the specified unit, which includes a linear PCM signal.

14. The reception apparatus according to claim 13, further comprising
a processor that performs processing on the compressed audio signal and the linear PCM signal to obtain an output linear PCM signal.

15. The reception apparatus according to claim 14, wherein
configuration information indicating a configuration of the linear PCM signal is added to the audio signal received by the reception section, and
the processor performs processing on the linear PCM signal on a basis of the configuration information.

16. The reception apparatus according to claim 14, wherein
information related to the linear PCM signal is added to the audio signal received by the reception section, and
the processor performs processing on the linear PCM signal on a basis of the information related to the linear PCM signal.

17. A reception method, comprising
receiving an audio signal continuous for each specified unit from a transmission side through a specified transmission line, the audio signal continuous for each specified unit being obtained by alternately arranging the audio signal in the specified unit, which includes a compressed audio signal, and the audio signal in the specified unit, which includes a linear PCM signal.
